(19) United States
(12) Patent Application Publication
(10) Pub. No.: US 2009/0053084 A1
(43) Pub. Date: Feb. 26, 2009

(54) ROLLER PUMP AND PERISTALTIC TUBING WITH ATRIUM

(76) Inventor: Jeffrey A. Klein, San Juan Capistrano, CA (US)

Correspondence Address: STETINA BRUNDA GARRED & BRUCKER, 75 ENTERPRISE, SUITE 250, ALISO VIEJO, CA, 92656, US

(21) Appl. No.: 12/052,969

(22) Filed: Mar. 21, 2008

Related U.S. Application Data
(60) Provisional application No. 60/957,055, filed on Aug. 21, 2007.

(51) Int. Cl. F04B 43/12; F16L 11/00

(52) U.S. Cl. 417/477.1; 417/474; 138/118

(57) ABSTRACT

A single piece of extruded peristaltic roller pump tubing may have an inside diameter and outside diameter and wall thickness that may vary from one segment to next along its length. The tube may be formed with an atrial segment having an OD that is larger than the ventricular OD. Also, the arterial segment wall can be distensible and may be fluted. A peristaltic pump head assembly may have a C-shaped tube-holder which has no moving parts; secures the tubing 10 in pump assembly without the clamps, flanges or other tube-attaching devices; and provides a safer method for inserting the tubing into the pump head assembly. The inner diameter of the C-shaped tube-holder may be smaller than the OD of the atrial segment such that the atrial segment becomes snuggly wedged in the holder and prevents the incremental migration of the tubing through the roller raceway in the direction of the pump roller assembly rotation.

### CROSS-REFERENCE TO RELATED APPLICATIONS

This application claims the benefits of U.S. Provisional Patent Application Ser. No. 60/957,055, filed Aug. 21, 2007, the entire content of which is expressly incorporated herein by reference.

### STATEMENT RE: FEDERALLY SPONSORED RESEARCH/DEVELOPMENT

Not Applicable

### BACKGROUND

The present invention relates to the tubing used in peristaltic pumps and to peristaltic roller pump head assemblies. The tubing may be a single use, sterile, disposable plastic tubing used for gently pumping extracorporeal blood, and/or a tubing used for vigorously infiltrating large volumes of tumescent local anesthesia into subcutaneous tissue. The peristaltic roller pump head assembly has been simplified. The tubing and peristaltic pump have other commercial, industrial, laboratory and clinical applications.

A peristaltic pump is a mechanical pump in which pressure is provided by the movement of a constriction along a tube, as in biological peristalsis. The constriction or pumping action is usually provided by the movement of one or more rollers rotatably mounted on a fixture which in turn rotates on an axis. The movement of the rollers along a segment of the tube within the pump raceway propels fluid through the tubing. There are several interrelated factors that determine an appropriate pumping rate (milliliters per minute) of blood. These factors include the dimensions and elastic quality of the tubing, and the rate of compression applied by the pump rollers. Peristaltic pumps can have a linear shoe or circular rollers which compress the tubing within a linear or circular raceway, respectively. The pump tubing is placed into the raceway and traditionally fixed by means of clamps, flanges or fixtures. Synonyms for peristaltic pump are roller pump, tube pump, and hose pump.

Traditional peristaltic roller tubing includes a venous, inlet, vacuum or proximal end, an arterial, outlet, pressure or distal end, and a central pumping or ventricular segment which interacts with the rollers. An example of a peristaltic pump used for tumescent infiltration is the Klein Pump (HK Surgical, Inc, US 2004/0213685, October 2004, Klein).

The rate of fluid flow produced by a peristaltic pump is a function of 1) the angular velocity of the roller assembly and 2) the volume of fluid contained within the tubing delimited by constrictions produced by two consecutive rollers. For any given pump flow-rate requirement, it is desirable to optimize these two factors. Reducing the angular velocity of the roller assembly reduces wear-and-tear on the portion of the tubing that is repeatedly compressed by the rollers (tubing fatigue) and also minimize the incidence of roller-induced crush injury to the cellular components of blood. Excessive rotation rates of the peristaltic pump rollers can damage the cellular and macromolecular components of whole blood. An increase the inside diameter of the pump tubing within the pump raceway will increase the volume of fluid pumped with each cyclic compression of the tubing.

A ventricular segment is a tubular segment of peristaltic roller pump tubing located between the inlet and outlet segments of tubing. The ventricular segment is the segment inserted into the pump raceway and cyclically compressed by the pump rollers. The ventricular segment is responsible for the pumping efficiency of a peristaltic pump. The larger the internal diameter (ID) of the ventricular segment, the greater will be the volume of blood ejected with each cyclic compression of the pump. The word ventricle is an anatomic term and a diminutive form derived from the Latin ventre: a womb-like cavity, hence a cavity in the heart, brain, etc.

Virtually all peristaltic pumps employ a mechanical system to forcibly constrict the tubing clamps, attachment flanges, connection brackets, or special fixtures that attach to the metal, plastic or glass connectors that join sequentially connected segments of tubing. Some pump designs employ a clamping mechanism designed to squeeze the tube and hold it in place by virtue of a crimping deformation of the tube. There is need for a simplified system for securing a peristaltic tube to the pump head assembly.

A venous segment of peristaltic roller pump tubing is the proximal or inlet segment of the tubing. The venous fluid pressure is relatively low.

Fluid flows into the venous segment from a reservoir source, entering into the tubing via the proximal end and is drawn distally by the negative pressure generated by the peristaltic pump. The cyclic action of the rollers generates a cyclic abrupt pulsatile turbulent flow through the venous segment. An atrial segment can minimize turbulent venous flow by dampening pulsatile surging in the venous segment.

An arterial segment of peristaltic roller pump tubing is the distal or outlet segment of the tubing. The arterial segment is bounded proximally by a ventricular segment of the tubing. Fluid flows from ventricle into the arterial segment pushed by the positive pressure generated by the peristaltic pump rollers. Analogous to the mammalian cardiovascular system, laminar quality of the flow through the arterial segment of a roller pump tube can be optimized by a distensible elastomeric tube which can dampen pulsatile pressure surges.

Raceway is a course or passage for a shuttle or roller; also, a groove in which ball-bearings run. The raceway of a roller pump is a segment of a circular concave surface upon which circular rollers compress an elastomeric tube during peristaltic pumping.

Fluted is an adjective describing an object having, furnished, or ornamented with flutes, channels, or grooves; from Flute (Architecture) A channel or furrow in a pillar, resembling the half of a flute split longitudinally, with the concave side outwards.

Restitution refers to the action of restoring a thing to its original state or form. Restitution of roller pump tubing is a term that describes the elastic recoil quality of tubing, in particular, its ability to quickly return to its uncompressed tubular shape following the release of a compressive deforming force. Restitutional power of peristaltic tubing refers to its power to create a negative pressure (suction) within its venous (input, upstream) section. Restitutional power describes a tube's ability to produce suction lift and fully return to its resting shape before the advance of the next roller. If it does not fully return to its resting shape, the flow rate is reduced. The restitutional power of the tubing is responsible for the transient vacuum that draws fluid from the reservoir source through the venous segment and into the ventricular segment.

The overall functional efficacy of a peristaltic pump system depends on a combination of both the pump roller system and the pump tubing. Pump tubing is at least as important as the pump motor and roller housing in terms of overall performance and reliability.

Resistance to flex is a determinant of both the longevity of a tube's pumping life and the tubes tendency to kink. Flex resistance increases with increasing wall thickness and with increasing durometer.

Durometer is one of several ways to indicate the hardness of a material, defined as the material's resistance to permanent indentation. It is named for instrument maker Albert F. Shore, who developed a measurement device called a durometer in the 1920s. The term durometer is often used to refer to the measurement, as well as the instrument itself. Durometer is typically used as a measure of hardness in polymers, elastomers and rubbers.

Gap is an opening or breach by which entry may be made in an otherwise continuous object.

The outside diameter (OD) of a tube is the diameter of the circle congruent with the outer surface of a circular tube.

The internal diameter (ID) of a tube is the diameter of the lumen of a tube having a circular-cross-section. The ID of the ventricular segment of peristaltic pump tubing is an important factor in determining the volume of fluid that is pumped in one 360 degree cycle of the peristaltic pump. Tube life is maximized by using a tube having a large ID at a roller pump speed that is relatively slow. Flow rate is maximized by using a tube having the largest tube ID at a roller pump speed that is relatively high. To achieve maximum pump precision, one should use tubing having a small ID at maximum speed.

Wall Thickness is the thickness of the wall of a section of peristaltic tubing. The maximum pressure-handling capability for peristaltic pump tubing of a given outside diameter is achieved with the largest wall thickness (smallest bore size) of tubing which will provide the required flow rate. A large wall thickness decreases the tendency of a tube to kink.

Permeability of the tube material is relevant to peristaltic pumping when handling fluids or gases that are to be analyzed for their gas content, or where there is a chance of a gas permeating into the fluid and influencing a reaction. Note that the higher the value, the more gas will permeate through the tube wall. Silicone is the most gas permeable material in the range and PVC is the least.

Spallation refers to the detachment of a number of fragments from a larger piece of a substance as a result of traumatic impact. Spallation is derived from the verb to spall, to break into smaller pieces, to split or chip, to detach as small fragments or particles. In the long term use of peristaltic pumps, spallation can lead to tube failure. Spallation is generally not a concern with modern tubing material, especially for relatively brief clinical procedures.

Lubricity refers to the slipperiness and smoothness of the external or internal surface of the tubing. For most industrial applications of peristaltic pumps, lubricity is not a significant consideration. However, for the transport of a delicate fluid such as blood, a high degree of lubricity may facilitate laminar flow within the tubing and minimize micro-fluidic trauma to blood cells at any blood-tubing interface.

Coatings of tubing surfaces with anti-thrombogenic materials, such as complexes of heparin with quaternary ammonium compounds, can be applied to the luminal surface of the tubing to prevent formation of blood clots on the tubing surface. A hydrophilic coating can also increase lubricity.

Fluid Dynamics

Pulse pressure, the difference between the maximum (systolic) and the minimum (diastolic) pressure of arterial blood.

Turbulent flow is flow of a fluid in which the velocity at any point fluctuates irregularly and in which there is continual mixing rather than a steady flow pattern.

Laminar flow of a fluid is smooth and regular, the direction of motion at any point remaining generally constant as if the fluid were moving in a series of layers sliding over one another without mixing.

Bernoulli's Equation for a horizontal tube containing a fluid of density ρ is

P₁+½ρV₁²=P₂+½ρV₂²

where Pᵢ=pressure and Vᵢ=velocity of flow for any two points point Xᵢ, i=1, 2.

Bernoulli's equation tells us that if pressure at a point within the fluid decreases, then the speed of a fluid particle passing through that point must increase as it moves along a horizontal streamline, and conversely. For laminar flow through distensible tubing, any incremental increase in the cross-sectional area of the tubing yields a localized incremental decrease in pressure. Bernoulli's equation shows that such a local decrease in pressure yields a local increase in fluid velocity. Thus distensible tubing increases the rate of fluid flow.

Shear stress is an action, resulting from applied forces, which tends to cause two contiguous parts of a body to slide relatively to each other in a direction parallel to their plane of contact; also called tangential stress. Shear stress within blood flowing near a vessel wall is the strain within the fluid on a red blood cell that is proportional to its distances from the wall. The closer a red blood cell is to the static wall, the greater the sheer stress. Shear stress has been shown to cause hemolysis.

Rheology is the study of the fluidic deformation and flow of matter, especially the flow of non-Newtonian liquids and the plastic flow of solids. Thus the rheological properties of blood containing a suspension of cells within proteinaceous serum are not the same as an ideal Newtonian fluid.

Reduction of Pump Related Hemolysis

There is a need for an innovative tubing design that can minimize traumatic injury and destruction of the various components of whole blood. This includes mechanical destruction of red blood cells (mechanical hemolysis), white blood cells (mechanical neutropenia), platelets (shear induced platelet aggregation and thrombocytopenia), and consumption of clotting factors (consumption coagulopathy).

Blood trauma and hemolysis are significant continuing problems for extracorporeal membrane oxygenation, circulatory assist devices, and hemodialysis. Traumatic hemolysis and subhemolytic trauma are the result of multiple factors including aberrant fluid dynamics and interactions between cells and artificial materials. Turbulent blood flow and abnormal pressure gradients place a mechanical load on blood cell-membranes by means of non-physiological high shear stresses.

Mechanical blood damage is a function of both shear stresses and the duration of exposure to non-physiologic turbulence. The micro-fluidic environment of blood within a mechanical pump consists of rapid abrupt longitudinal start-stop oscillatory motions, and turbulent flow at any blood-tubing interface along any microscopically rough surface of the tubing wall. There is also blunt trauma to cellular elements as the result of crush injury induced by the squeezing action of the peristaltic pump rollers. Relatively stiff non-distensible tubing produces high pulse pressures similar to the adverse environment of atherosclerotic arteries.

Turbulent stresses contribute to mechanical damage to cellular blood components. Experimental studies have shown that hemolysis is significantly greater with turbulent blood flow as compared to laminar flow. (Kameneva MV et al. Effects Of Turbulent Stresses Upon Mechanical Hemolysis: Experimental And Computational Analysis. ASAIO J 50:418-23, 2004)

White blood cells (WBCs) function is impaired at lower levels of shear stress compared to WBC hemolysis. Red blood cells (RBC) have structural properties that affect flow dynamics including aggregability, deformability, and adherence to vascular endothelial cells. Compared to young RBCs, older RBCs demonstrate increased mechanical fragility, decreased deformability, and an increased tendency to aggregate. RBCs exposed to turbulent shear stresses demonstrate similar pathologic changes. Mechanical stress is analogous to accelerated RBC aging. (Kameneva M V et al. Mechanisms of red blood cell trauma in assisted circulation. Rheologic similarities of red blood cell transformations due to natural aging and mechanical stress. ASAIO J 41:M457-60, 1995).

There is a need to minimize exposure time to pump tubing by shortening the transit times along any given length of tubing, and to improve the laminar quality of flow through the tubing and thereby decrease hemolysis and subhemolytic damage to all blood components including platelets, white blood cells and red blood cells.

Infiltration of Tumescent Local Anesthesia

Tumescent or tumescence refers to the state of being swollen and firm. Infiltration is an injection that causes a fluid to permeate or percolate through pores or interstices. Thus an infiltration refers to an injection directly into tissue. Tumescent infiltration is a clinical technique for infiltration of very large volumes of very dilute solutions of therapeutic substances dissolved in a crystalloid solution such as physiologic saline or lactated Ringer's solution into subcutaneous tissue to the point of causing the targeted tissue to become swollen and firm or tumescent. Synonyms for tumescent infiltration are tumescent technique, tumescent delivery, and tumescent drug delivery. Tumescent local anesthesia is a very dilute solution of lidocaine (≦1 gram per liter) and epinephrine (≦1 milligram per liter) with sodium bicarbonate (10 milliequivalents per liter) in a crystalloid solution such as physiologic saline or lactated Ringer's solution. Tumescent liposuction is surgical technique for doing liposuction totally by local anesthesia using tumescent local anesthesia. Tumescent liposuction using TLA is far safer than liposuction performed under general anesthesia.

Tumescent liposuction can involve the infiltration of several liters of tumescent local anesthesia into the targeted areas of subcutaneous fat. Tumescent anesthesia infiltrated into the peri-venous compartment of the greater saphenous vein is essential for endovenous laser ablation of the saphenous vein in patients with symptomatic varicose veins. In both clinical situations surgeons rely on the use of a peristaltic pump to accomplish the infiltration of tumescent local anesthesia. In clinical applications it is essential that the peristaltic tubing be sterile and disposable. At present the most widely used disposable peristaltic tubing used for tumescent infiltration is hand assembled from seven separate components which include two lengths of IV tubing, one length of silicone tubing, plastic two connectors, and two cable-ties.

Commercial tubing that is available for peristaltic tumescent infiltration pumps which infiltrate large volumes of dilute local anesthesia into subcutaneous fat is constructed of seven parts plus two end connectors. The seven parts consist of three tube segments (one piece of silicone tubing and two pieces of IV tubing made of PVC), two plastic connectors and two nylon cable-ties.

The function of an IV tube drip chamber is well known in the art of clinical medicine. The drip chamber in the prior art is typically formed of at least three separate components: a clear plastic cylindrical tube that forms the side wall of the drip chamber and is bonded at its proximal end to a plastic cap having an integral IV-bag-spike; the clear plastic cylindrical tube is similarly bonded distally to a cap having a central hole with an attachment for the IV tubing such that the IV tubing is in fluid communication with the IV bag.

Thus there is a need for inexpensive disposable sterile peristaltic roller pump tubing which requires much less hand-assembly and is therefore much less expensive. It is also desirable that such a peristaltic tube be usable in peristaltic pumps made by a wide variety of manufacturers. It is also desirable that the peristaltic tube be usable in a novel peristaltic pump which has a greatly simplified design and is much less expensive to manufacture.

### DISCUSSION OF RELATED ART

The following US patents are of interest in the discussing below:

| Patent No. | Issue Date | Inventor(s) |
|---|---|---|
| 4,954055 | Sep. 4, 1990 | Raible |
| 4,347,874 | Sep. 7, 1982 | Sullivan et al |
| 5,468,129 | Nov. 21, 1995 | Sunden et al |
| 5,482,447 | Jan. 9, 1996 | Sunden et al |
| 4,976,590 | Dec. 11, 1990 | Baldwin |
| 5,215,450 | Jun. 1, 1993 | Tamari |
| 5,222,880 | Jun. 29, 1993 | Montoya et al |
| 5,342,182 | Aug. 30, 1994 | Montoya et al |
| 5,486,099 | Jan. 23, 1996 | Montoya |
| 4,515,536 | May 7, 1985 | van Os |
| 3,042,045 | Jun. 1, 1965 | Sheridan |
| 3,875,970 | April 1975 | Fitter |
| 3,105,447 | October 1963 | Ruppert |
| 5,067,879 | Nov. 26, 1991 | Carpenter |
| 2003/0132552 | Jul. 17, 2003 | Gamble et al |
| 2004/0213685 | October 2004 | Klein |

Roller pump tubing can be disposable and designed specifically for specific clinical, commercial, industrial, or research application. For clinical application involving extracorporeal circulation of blood the goal is to minimize red blood cell hemolysis and damage to other blood components. For many surgical applications the goal is to provide an inexpensive reliable disposable sterile tubing that facilitates the infiltration of solutions of tumescent fluids such as tumescent local anesthesia (TLA).

Currently the peristaltic tubing set that is most widely used for tumescent infiltration is hand assembled from 7 components in addition to two connectors, one bonded to the proximal end and the other bonded to the distal end of the tubing. The seven components consist of two lengths of IV tubing formed from polyvinyl chloride (PVC), one length of silicone tubing, two plastic tube-adaptors, and two nylon zip-ties. The tube is hand assembled as follows: first a length of IV tubing is bonded to the inside of a plastic tube-adaptor, then the remaining length of IV tubing and the remaining plastic tube-connector are bonded in a similar fashion; next the free ends of the two plastic tube-adapters are inserted into the ends of the silicone tube, and finally nylon zip-ties are placed and tightened around the ends of the silicone tube that encompass the plastic tube-connectors. The segment of silicone tubing is the segment upon which the peristaltic rollers compress the tubing during the pump operation. This hand assembled tubing set is relatively expensive. Another disadvantage of the present tubing is that these hand-assembled tubes may leak at either the bonded joints or at the joints secured by the zip-ties. Thus there is a need for a roller pump tube that is extruded as a single piece of PVC tubing that minimizes hand assembly and is therefore less expensive and less likely to leak.

Peristaltic roller pump head assemblies are well known and widely used in medical, commercial, industrial and research applications. Among the disadvantages of roller pump head assemblies that are commercially available at present are 1) pump head assemblies can be rather expensive, 2) they have many moving parts other than the rotating peristaltic roller assembly, 3) they require tube clamps or attachment brackets which have moving parts that are utilized to secure the tube within the roller raceway and thereby prevent incremental migration of the tube through the roller pump head assembly as the result of the cyclic vector force applied to the pump tube by the rotating roller assembly 4) safety considerations demand that there be plastic cover or other hood-like protective device that covers the rotating roller assembly in order to prevent entrapment of fingers or entanglement of clothing within the rotating roller assembly, and 5) safety considerations furthermore require that peristaltic roller pump motor must automatically be prevented from being actuated whenever the protective cover is not closed and in place. Thus there is a need for a peristaltic roller pump head assembly which has the following characteristics: 1) it is substantially less expensive than pumps that are currently on the market, 2) it has fewer moving parts, 3) has no clamps or detachable attachment devices, 4) does not require a hood-like protective device, and 5) does not require expensive programming and electrical-sensing devices which prevents motor actuation when the protective hood is not properly positioned.

Raible et al (U.S. Pat. No. 4,954,055, issued Sep. 4, 1990) Variable Roller Pump Tubing: Raible appears to disclose a single piece of extruded peristaltic pump tubing that has a central dilated segment that contacts the pump rollers and thereby increases the flow rate per pump cycle. As understood, Raible is formed with “two end portions of substantially similar internal diameter with the diameter of the tube gradually increasing towards the central section” wherein the “wall thickness of the tubing wall is substantially equivalent along its entire length.” The Raible pump tubing, designed for extracorporeal circulation, appears to be extruded from as a single tube with smooth continuous transition from narrow to dilated inside diameter, thereby reducing hemolysis associated with the sharp corners in tubing constructed from separate pieces joined by angular tube connectors. Raible states that the tubing should have a constant wall thickness. Thus there is a need for extruded peristaltic tubing having design features that optimize fluid-dynamic which minimize hemolysis such as tubing having variable wall thickness.

Sullivan et al (U.S. Pat. No. 4,347,874 issued Sep. 7, 1982), High Speed Sterile Fluid Transfer Unit: Sullivan discloses “a large diameter silicone rubber tubing for use with a peristaltic type roller pump firmly pre-connected between two pieces of one-eighth diameter tubing . . . ” for transferring pharmaceutical liquids from a large multi-dose bottle into smaller single dose bottles. “The connections between the silicone rubber tubing and the smaller diameter plastic tubing are accomplished by the use of custom fitted spike-type plastic fittings which penetrate the silicone rubber tubing and which are cemented to the plastic tubing, and avoid any possibility of the seals being broken and the liquid being spilled.” As understood, the automated transfer of pharmaceutical liquids between bottles does not involve high fluid pressures. In contrast, when a peristaltic pump is used to facilitate the tumescent infiltration of large volumes of dilute local anesthetic into a patient's subcutaneous fat, the pressures within the infiltration tubing (peristaltic roller pump tubing) can cause leakage of fluid at the point of connection between a spike-type plastic press-fitted attachment and a segment of silicone tubing. There does not appear to be an adequate method of gluing or welding silicone to plastic or polyvinylchloride (PVC). When currently available commercial tubing is used for high pressure tumescent infiltration, the silicone-PVC connections require hand-assembly of connections using nylon cable-ties to bind the silicone tubing to the plastic connector fitting. Thus it is believed that the current design for a tumescent infiltration tubing set for use with a peristaltic pump consists of seven components: two pieces of small diameter PVC tubing (inlet and outlet segments), one piece of larger diameter silicone tube segment, two pieces of plastic connector fittings (one end of which is slipped into the inside diameter of the silicone tubing and secured in place by a nylon cable-tie and the other end of which is slipped over the outside diameter of the PVC tubing and glued in place), and two pieces of nylon cable-ties. Thus there is a need for a less expensive more simply constructed peristaltic tube set with fewer component parts having reduced risk of leakage.

Sunden et al (U.S. Pat. No. 5,468,129) Peristaltic Pump, issued Nov. 21, 1995 and Sunden et al (U.S. Pat. No. 5,482,447) Peristaltic Pump, issued Jan. 9, 1996: Sunden et al disclose a reusable pump tube “constructed of relatively hard, rigid materials which can only be compressed by applying significant force.” It has two layers, the inner of which is resistant to corrosives, hot, and/or high pressure fluids. The pump tube, being “flattened, and shaped to conform to the pumptube passageway,” has “significantly reduced tendency to be pulled into the pump”. The tubing of Sunden appear to be constructed of three separate tubes which must then be glued or welded together. Furthermore the tubing appear to require a specifically designed pump roller system, and may not be used by “generic” laboratory, industrial or clinical peristaltic pumps. It would be desirable to have a simplified tubing, rather than a tube constructed from multiple separate tubes glued together.

Baldwin, (U.S. Pat. No. 4,976,590) issued Dec. 11, 1990. Fluid Conduit-Responsively Adjustable Pump Arrangement and Pump/Conduit and Method, and Fluid Conduits Therefor: Baldwin appears to disclose a pump with a “set of plural sizes of tube set conduits . . . with special anchor-connecting flanges on the tube set conduits . . . with corresponding anchoring anchor-connection slots on the pump.” Baldwin's tube set has inlet and outlet tubing that are of smaller diameters than the central tube segment compressed by the pump rollers. These three tube segments are connected via special connectors which also function to secure the tubing within the roller pump housing. Traditional peristaltic pumps may have a significant problem with a tendency for the tubing to be forced through the pump raceway in the direction of roller assembly rotation. If a tube moves out of position within the pump either pump-function deteriorates or the tubing becomes damaged and fails. Prior-art pumps are designed with clamp-devices, connection-flanges or tube-holding mechanisms to prevent tubing migration out-of-position. Such devices increase the number of components and the cost of pump-manufacturing. Furthermore these connection-devices themselves can either fail or damage the tubing. Thus there is a need for a tube-pump system with no need for multiple separate components to anchor the tube within the pump.

Montoya et al, U.S. Pat. No. 5,342,182, Self Regulating Blood Pump with Controlled Suction, issued Aug. 30, 1994 and U.S. Pat. No. 5,486,099, Montoya, Peristaltic Pump with Occlusive Inlet, issued Jan. 23, 1996: Montoya appears to disclose tubing “provided with a variable cross-sectional width” which is designed to “minimize the total pump priming volume”. The Montoya tubing set appears to be of a shape which is naturally flat and occluded when the pressure within the tubing is equal to or less than the ambient pressure. Additionally, the shape of the tubing in the Montoya invention allows tubing to assume its completely occluded position without inducing high bending stresses along the edges of the tubing. Montoya places the roller assembly and the pump tubing with an occlusive inlet within an air-tight container with the ability to regulate the internal pressure of the container and thereby control the patency of the pump tubing. Montoya appears to be motivated by the need to prevent an over-pressurized conduit in involving extracorporeal blood circulation.

van Os (U.S. Pat. No. 4,515,536), May 7, 1985, Peristaltic Pump: van Os discloses peristaltic pump tubing which may have two mounting flanges. “The hose has constant wall thickness along the entire length between the supply end and the discharge end and a constant inner circumferential length of the cross-section.” Beginning at both ends, the tube is circular in cross section and “gradually becomes flatter and broader.” This inner tube is contained within a surrounding tube with the space between the tubes sealed at both ends; into this space a hydraulic fluid is forced which in turn squeezes the inner tube and assists in the production of a peristaltic pumping of pumpable material. The intention of this invention appears to be that the resulting peristaltic operation “does not result in damage to the particles present in the pumpable material.” In other words, this invention appears to avoid the crush injury to blood cells by an occlusive roller pump.

Fitter (U.S. Pat. No. 3,875,970) issued Apr. 8, 1975, Tubing: Fitter discloses a concentric multilayer pump tube. In industrial and scientific applications of peristaltic roller pumps, the tubing should be resistant to harsh and corrosive chemicals. Tubing material that is resistant to corrosive chemicals is usually stiff and not resilient. On the other hand tubing material that is resilient and has good restitutional power is typically not resistant to hash chemicals. Fitter appears to attempt to overcome the problem of finding a tubing material having both good corrosion resistance and good resilience by providing a two-layered tube wherein a thinner corrosion resistant inner layer is bonded to a thicker resilient elastomeric outer layer.

Ruppert (U.S. Pat. No. 3,105,447) issued Oct. 1, 1963, Pump Construction: Ruppert appears to disclose a double layered pump tube having an inner and an outer tube. The design appears to allow a lubricant to be pumped through the space formed between the two tubes in order to reduce the friction between the roller and the tubing.

Carpenter (U.S. Pat. No. 5,067,879) issued Nov. 26, 1991. Peristaltic Pump System: Carpenter appears to disclose a flexible, single-layer or multi-layer pump tube having two longitudinally extending notches or grooves in the outer surface to improve the flexing characteristics of the tube during compression and recovery, and which facilitates maximal occlusion. Carpenter does not appear to be concerned with tube cross-sectional geometry in tube segments which are far from the compressive rollers of a peristaltic pump.

Tamari (U.S. Pat. No. 5,215,450, Jun. 1, 1993) Innovative Pumping System for Peristaltic Pumps Tamari discloses a peristaltic pump tube which has at least one longitudinal portion of its wall thin. Thus it is believed that the tubing wall thickness is variable only along that portion of tubing that is located within the raceway and is compressed by rollers.

### BRIEF SUMMARY

This disclosure discloses both a single piece of extruded tubing for use in a peristaltic roller pump having inside diameter (ID) and outside diameter (OD) and wall thickness (WT) which varies from one segment to next along the length of the tubing and a novel peristaltic pump head assembly with a C-shaped tube-holder that secures the tubing in the pump assembly without the necessity of clamps or flanges.

The requirements for safe infiltration of tumescent local anesthesia are not as demanding as the requirements for pumping blood through extracorporeal circuits. Thus most of the following discussion is focused on peristaltic roller pump tubing used for pumping blood, including the delicate blood cellular components, in an optimal and minimally traumatic fashion. The infiltration of tumescent local anesthesia is also discussed. All aspects discussed herein apply to any application of peristaltic pumping currently known in the art or developed in the future.

The tube may be made of an elastomeric material and may consist of a distal arterial segment, a central ventricular, a central atrial segment which is immediately proximal to the ventricular segment and a proximal venous segment. The ventricular segment has an OD that is greater than or equal to the OD of the arterial segment and greater than or equal to the OD of the venous segment. The atrial segment has an OD that is larger than the ventricular OD. Proximal to the arterial segment there is a transitional segment wherein the OD, the ID and the WT can increase continuously in the direction of the adjacent ventricular segment. Proximal to the ventricular segment there is a transitional segment wherein the OD and ID can increase continuously in the direction of the adjacent atrial segment. Proximal to the atrial segment there is a transitional segment wherein the OD and ID can decrease continuously in the direction of the adjacent venous segment. The ventricular segment is compressed by the pump rollers. The ventricular WT may be approximately half the magnitude of the gap or distance between the concave surface of the raceway and the surface of the pump rollers. A proximal inlet or venous segment and a distal outlet or arterial segment can have similar IDs, which can be smaller than either the ID of the ventricular segment or the atrial segment.

The WT of the arterial segment can be smaller than the WT of the venous segment.

The thinner elastomeric wall of the arterial segment imparts a distensible quality to the tubing which reduces the pulsatile and turbulent quality of fluid flow along the arterial segment. The cross-sectional shape of the tubing can be circular, elliptical, scalloped or some other geometric shape. Segments of the tubing may have longitudinal internal and external fluting, which increases the effective surface area of the tubing thereby improving distensibility. When the fluting is straight, it can improve laminar flow characteristics and dampen the transmission of pulsatile pressure waves generated by the rollers. When the fluting is helical, the internal lumen of the tubing becomes rifled with helical grooves that improve mixing of fluids and produces fluid warming by virtue of friction between the fluid and the tubular lumen.

The atrial segment may provide a fluid reservoir for the fluid volume about to be rapidly sucked into the ventricular segment of the roller pump tubing. This atrial reservoir effectively reduces turbulence and reduces high velocity cyclical surging of fluid flow through the length of the venous inlet segment. At a point along the transitional segment between the ventricular segment and atrial segment, the OD of the atrial segment, when inserted into a C-shaped tube-holder of the peristaltic pump head assembly, becomes snuggly wedged within the C-shaped tube-holder thereby preventing the incremental migration of the tubing through the raceway in the direction of the pump roller rotation.

An outer tube may concentrically overlie the thin-walled arterial segment. The resulting tube assembly has improved resistance to kinking, while still able to dampen of arterial pulsations and improve laminar flow.

The novel peristaltic roller pump head assembly and roller pump housing eliminate numerous parts from prior-art roller pumps and provide a safer and simpler method for inserting the tubing between the rollers and the pump raceway. A method for inserting a tube set into a roller pump head assembly is provided wherein the tube set has a distal Luer connector and a proximal spike for an IV bag and a ventricular tube segment, all of which have ODs which are larger than the gap between the rollers and the roller raceway within the peristaltic roller pump head assembly.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a prospective view of a distensible peristaltic roller pump tube with an atrial segment with section lines indicating transverse cross-sectional views at the level of the arterial segment 3A, ventricular segment 3B, atrial segment 3C, and the venous segment 3D;

FIG. 2 is a longitudinal cross-sectional view of the distensible tube illustrating sub-segments: a distal end, a proximal end, an arterial distal outlet segment, a venous proximal inlet segment, a ventricular segment upon which a pump roller compress the tubing, a transition segment between ventricular and arterial segments, an atrial segment, a transition segment between the atrial and ventricular segments, and a transitional segment between the venous and atrial segments.

FIG. 3A is a cross-sectional view of the tube taken across lines 3A-3A of FIG. 1;

FIG. 3B is a cross-sectional view of the tube taken across lines 3B-3B of FIG. 1;

FIG. 3C is a cross-sectional view of the tube taken across lines 3C-3C of FIG. 1;

FIG. 3D is a cross-sectional view of the tube taken across lines 3D-3D of FIG. 1;

FIG. 4A is a perspective view of the C-shaped tube-holder for securing and fixing the tube while it is situated within a peristaltic roller pump assembly;

FIG. 4B is a perspective view of the roller pump tubing 10 positioned within the C-shaped tube-holder, with section lines indicating transverse cross-sectional views at the level of the C-shaped tube-holder 40 and the transitional segment 23 between the ventricular and atrial segments, and at the level of the arterial segment 4C;

FIG. 4C is a frontal view of FIG. 4A;

FIG. 4D is a cross-sectional view of the tube and tube holder taken across lines 4D-4D of FIG. 4B;

FIG. 4E is a cross-sectional view of the tube taken across lines 4E-4E of FIG. 4B;

FIG. 5A is a partial cross-sectional view of an alternate embodiment of the tubing with a second axially concentric tube overlying the relatively thin walled arterial segment;

FIG. 5B is an enlarged view of the arterial portion of the cross-sectional view of 5A

FIG. 5C is an enlarged view of the distal end of the cross-sectional view of 5B;

FIG. 6A is a prospective view of an alternate embodiment with two atrial segments, one on either end of the ventricular segment;

FIG. 6B is a longitudinal cross-sectional view of FIG. 6A;

FIG. 7 is a prospective view of an alternate embodiment showing a tube having the equivalent of two of the tubes in a series arrangement;

FIG. 8A is a prospective view of a distensible tube with an atrial segment with longitudinal helical fluting along the arterial segment, with a section line 8C-8C indicating transverse cross-sectional view at the level of the arterial segment;

FIG. 8B is an enlarged view of arterial segment of FIG. 8A with longitudinal helical fluting, with a section line 8C-8C indicating transverse cross-sectional view;

FIG. 8C is a cross-sectional view taken across lines 8C-8C of FIGS. 8A and 8B. The cross-section can have a scalloped appearance;

FIG. 9A is a perspective view of a peristaltic roller pump assembly and pump housing with a C-shaped tube-holder 43, a cut segment of peristaltic pump tubing 10, arc-shaped raceway 19 and exposed pump rollers 36, with a section line 9C-9C indicating frontal cross-sectional view;

FIG. 9B is a frontal view of FIG. 9A with a cut segment of ventricular tubing 20 positioned within the pump and C-shaped tube-holder 43;

FIG. 9C is frontal section view of FIG. 9B as indicated by section lines 9C-9C shown in FIG. 9A, showing the peristaltic pump together with a cut segment of tubing 20;

FIG. 10A is a perspective view of an embodiment of a peristaltic roller assembly 28 and roller housing 32 with a C-shaped tube-holder formed as an integral part of the ring-shaped roller housing, which completely encloses the roller assembly, with a section line 10B-10B indicating frontal cross-sectional view;

FIG. 10B is a frontal section view of FIG. 10A as indicated by section lines 10B-10B. The cross section shows the peristaltic roller housing and roller assembly together with a cut section of tubing also shown in FIG. 10A;

FIG. 10C is a frontal section view similar to FIG. 10B without the section of cut tubing which has been removed in order to show important gaps within the peristaltic pump head assembly;

FIG. 11A is a prospective view of an embodiment of a peristaltic roller pump assembly with roller assembly housing and roller assembly together with the distensible peristaltic pump tubing with atrium with section lines indicating transverse cross-sectional views through 11D-11D;

FIG. 11B is a partial sectional view of 11A showing the ventricular segment 20 of the tubing compressed within the roller raceway by the rollers;

FIG. 11C is a sectional view similar to FIG. 11B without the tubing which ahs been removed in order to show important gaps within the peristaltic pump head assembly;

FIG. 11D is a sectional view of FIG. 11A taken though section lines 11D-11D;

FIG. 12A is a frontal view of peristaltic pump head assembly showing the initial step of inserting the tubing into the pump head assembly;

FIG. 12B is a frontal view of peristaltic pump head assembly showing the second step of inserting the tubing into the pump head assembly;

FIG. 12C is a frontal view of peristaltic pump head assembly showing the third step of inserting the tubing into the pump head assembly;

FIG. 12D is a frontal view of peristaltic pump head assembly showing the fourth step of inserting the tubing into the pump head assembly;

FIG. 12E is a frontal view of peristaltic pump head assembly showing the tubing well inserted into the pump head assembly and ready for peristaltic pumping with section lines indicating transverse cross-sectional views through 12F-12F;

FIG. 12F is a section view of FIG. 12 E through section lines 12F-12F;

FIG. 13A is a cross-sectional view of the assembly 138 consisting of tube 130, which is an alternate embodiment of the tubing 10 shown in FIG. 2, and the IV-bag-spike 131 at the proximal end of tube 130;

FIG. 13B is an enlarged view of the proximal portion of the cross-sectional view of 13A;

FIG. 13C is prospective view of FIG. 13B with drip chamber 13 and IV-bag-spike 131

FIG. 14A is a prospective view of uniform roller pump tubing having an attached annular-shim;

FIG. 14B is a prospective view of a roller pump tube having dilated segment that functions as an atrium but lacks a discreet ventricular segment;

FIG. 14C is a prospective view of a roller pump tube having dilated segment which functions as a ventricular segment together with an annular-shim located proximal to the ventricular segment; and

FIG. 14D is a cross-sectional view of peristaltic pimp head assembly with a tubing positioned by an annular-shim disposed within a C shaped tube holder.

### DETAILED DESCRIPTION

A peristaltic roller pump tubing and an improved design for a roller pump head assembly are discussed herein. The pump tubing provides for optimal hematologic and physiologic compatibility. The peristaltic roller pump tubing is referred to as “roller pump tubing with atrium” or simply “atrial tubing”. The tubing may comprise a single piece of extruded tubing, with inside and outside diameters and wall thicknesses that vary along the length of the tubing. It can be made of silicone-replacement polyvinylchloride (SR-PVC) which has the resiliency and distensibility of silicone, but with the desirable qualities of PVC such as being easily bonded to other plastics, and being highly impermeable to gases and chemicals.

The number of pieces required to construct peristaltic infiltration-tubing may be reduced from seven parts to one piece of extruded silicone-replacement polyvinylchloride (SR-PVC) tubing having inside and outside diameters and wall thicknesses that vary along the length of the tubing. In particular, the tube does not need nylon cable-ties that are typically necessary to avoid high pressure leaks. The tubing obviates the risk of pressure-induced connection failures and leaks, simplifies the construction and assembly, and reduces the cost of production.

The roller tubing can have four distinct segments which are known as an arterial segment 16, a ventricular segment 20, an atrial segment 25, and a venous segment 18. In one possible embodiment these four distinct segments can consist of a distal arterial segment having OD and ID similar to that of IV tubing, a central ventricular 20 segment having OD and ID similar to ⅜ inch OD silicone tubing, a central atrial segment 25 immediately proximal to the ventricular segment having an OD that is greater than the OD of the ventricular segment, and a proximal venous segment having an OD that is similar to that of IV tubing.

The peristaltic pump tubing may involve two novel design features which minimize turbulence and reduce non-physiologic trauma to blood components by improving fluid-dynamic behavior; namely, the use of distensible tubing and a pre-ventricular atrium. For example, the distensibility of the tubing results in a pulsatile increase in cross-sectional area of the fluid flowing through the arterial segment of the tubing. The pulse induced incremental increase in cross-sectional diameter of the tubing produces a local incremental increase in volume and thus a local incremental decrease in pressure, which in turn yields, by virtue of the Bernoulli equation, an incremental increase in the velocity of fluid flow. These modifications reduce turbulence, improve laminar flow characteristics, increase velocity of fluid flow, reduce transit times, reduce longitudinal oscillations, reduce pulse pressures, and smooth fluid flow by reducing surge.

Distensible is an adjective describing a thing which is capable of being distended or dilated by stretching.

Distensible tubing has advantages for improving fluid flow characteristics. The elastic quality of distensible tubes permits them to dilate when subjected to increased intraluminal pressure. Tubular distensibility D is quantifiable by the following formula: D*dp=(dv/V) where dp is the incremental increase in pressure, V is the initial volume, dv is the incremental increase in volume. Distensible tubes have two important hydrodynamic characteristics.

First, the regular pressure pulsations (periodic peaks of intraluminal pressure) produced by a peristaltic pump produce a dilation of elastic vessels which increases cross sectional area, thereby decreasing intraluminal resistance which results in an increase the rate of fluid flow. Second, there is a dampening or attenuation of the pulsatile nature of intraluminal pressure as the pulse travels distally.

When blood is flowing through the tube, dampening reduces the micro-fluidic trauma to blood. As blood flows more distally through pump tubing the flow becomes less pulsatile, less turbulent, and more laminar; thus hemato-cellular components are subjected to less hemolytic trauma. As an example of the adverse effect of inelastic tubing, one may consider the pathologic effects of atherosclerosis or the hardening of the arteries. When blood flows through elastic arteries, there is dampening which reduces chronic repetitive micro-trauma to end organ capillaries and minimizes its pathologic consequences, which include platelet activation with increased risk of micro-strokes and progressive renal damage.

Dampening has two causes: intraluminal resistance to fluid movement and distensibility of the tube. Resistance dampens pulsations because as a pulsation progresses distally a small amount of fluid must flow forward at the pulse wave front to distend the next segment of the tube, but resistance inhibits this incremental flow of fluid and causes dampening. Distensibility dampens pulsations because the more distensible the tube, the greater the volume of fluid required at the pulse wave front to cause an increase in pressure.

The distensible peristaltic pump tubing described herein optimize blood flow by two mechanisms. First, the ventricular pump contracts to produce a systolic pulse of increased pressure and the elastic arterial tubing expands radially to produce decreased intraluminal resistance. Second, the arterial elasticity cushions the abrupt pulsatile output of the pump, and averages out the pressure pulsations to produce a smoother continuous flow of blood, thereby protecting end organs from excessive pulse pressures.

The pre-ventricular atrium is one aspect of the present tubing. It is a dilated segment of tubing located immediately proximal to the ventricle, that portion of the tubing compressed by the pump's rollers. The atrium has a reservoir effect which reduces resistance to flow for fluid that is entering the ventricular segment, reduces fluid surge along the entire length of the venous segment of the tubing and attenuates the adverse effects of the negative pressure created by the intake vacuum of the peristaltic pump.

The distensible peristaltic pump tube and a peristaltic roller pump head assembly may together constitute a peristaltic pump system. The tube has variable wall thickness, variable diameter and an atrial segment. This tube is formed with two adjoining central sections having a wall thickness, an external diameter, and an internal diameter which can be greater than the remainder of the tube. In forming the tube, the wall thickness intentionally varies from one segment to the next. The wall thickness, and inside diameter of the tube can gradually increase to form a tapered zone between the end segments and the two adjoining central segments. The distensible tube with variable diameter and variable wall thickness is prepared from any suitable polymeric material, preferably a polyvinyl chloride (PVC) polymer having a Shore hardness that permits the PVC to be a substitute for silicone. In addition, the Shore hardness should impart a sufficient degree of distensibility so that pump-induced pressure pulsations within the tube lumen will cause the tubing to expand radially. The distensibility of the tube improves the laminar flow characteristics of the pumped fluid.

The atrial segment of the tube permits a peristaltic roller pump head assembly design that is significantly simplified with fewer parts and fewer moving parts than the roller pump head assemblies of prior-art roller pumps. The following discussion provides a detailed description of the tubing and roller pump assembly.

Silicone tubing has superior durability permitting it to be reusable and it has superior tolerance to heat which permits it to be sterilized in a steam autoclave. In contrast, Polyvinyl Chloride (PVC) is easily cemented to other plastics where silicone is incapable of being bonded to other tubing or plastic fittings. PVC is less permeable to gases and chemicals than is silicone. PVC is much less expensive than silicone. The SR-PVC tubing material possesses both the resiliency and distensibility of silicone. SR_PVC it can be easily bonded to plastic end-fittings such as an IV-bag-spike and a Luer-lock connector. For most medical applications peristaltic tubing is intended to be a disposable single-use item that it sterilized by ionizing radiation during the manufacturing and packaging process. PVC cannot be steam autoclaved thereby insuring that the single-use sterile tubing will not be re-used inappropriately.

The manufacturing process for controlling the dimensionally varying tube extrusion can be similar to processes well known to those familiar with the art of tube extrusion.

The wall thickness of the tubing is not equal along its entire length, but instead varies from segment to segment depending on the functional demands of each segment. The arterial segment being distensible may reduce turbulence, decrease resistance to fluid flow and dampen down-stream fluid pulsations induced by the roller pump. The tubing may have a central ventricular segment, compressed by the pump rollers, with an increased wall thickness which provides superior resilience and restitutional power. The atrial segment simplifies the task of preventing the tubing from migrating through the pump in the direction of the rollers. The atrial segment also improves hemodynamic flow between the venous segment and the ventricular segment by reducing fluid turbulence and shear stresses.

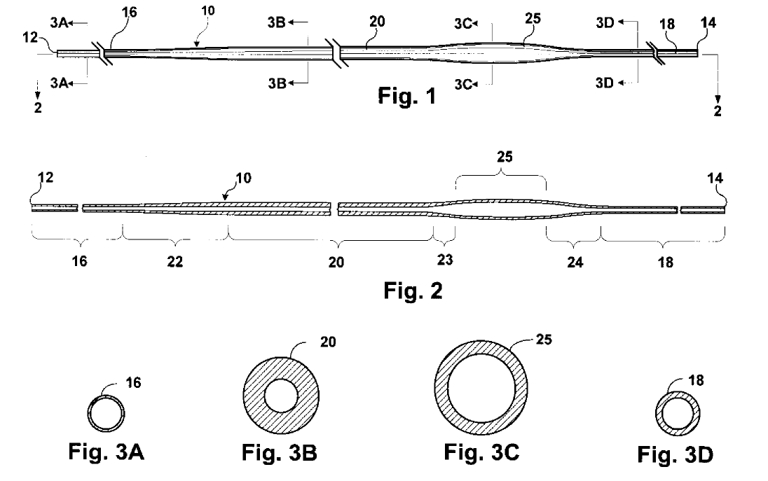

FIG. 1 is a prospective view of the tube and is generally identified as reference numeral 10. Tube 10 is an elongated cylindrical body having two opposing ends 12 and 14. The two end segments 16 and 18 are discrete portions of the overall length of the tube 10. End portions 16 and 18 generally possess similar internal diameters but may have different outside diameters. The distal end segment 16 is designated as the arterial segment. The proximal end segment 18 is designated as the venous segment. The atrial segment 25 is located proximal to the ventricular segment 20 and distal to the venous segment 18.

The venous segment is the portion of the tubing that transports fluid from a relatively low pressure fluid source such as a reservoir IV bag or the vein of a patient, to the atrial segment. The venous segment can have a thicker wall than that of the arterial segment and thus it is less distensible.

The atrial segment prevents slippage through a peristaltic pump. A common problem for peristaltic pump tubing is adequately fixing the position of the tubing within the pump raceway. Without a reliable method for securing the tubing is a fixed position, the tubing gradually migrates through the pump in the direction of the rollers as a result of the force vector in the direction of the roller-advancement imparted to the tubing by friction between the rollers and the tube. The atrial segment eliminates requirement for sophisticated connectors, flanges, brackets, and fixtures pump that hold the tubing in place.

The atrial segment acts as an intake reservoir for fluid. The atrial segment allows more laminar-like flow of fluid as it enters the ventricular compression segment of the tubing. The atrium improves efficiency by decreasing the time it takes to fill the ventricle.

The arterial segment of tubing has thinner wall thickness, which improves the distensibility of the tubing segment, and imparts an “elastic recoil-reservoir” effect on the fluid giving it more gentle, more continuous, less pulsatile flow characteristics. The arterial segment has a cross-section that is circular, or other geometric cross-sectional shapes such as elliptical, polygonal, or approximately circular with a scalloped circumference, or any other non-circular-cylindrical configuration.

FIG. 2 shows a sectional view of the tube in accordance with the tube is seen generally at 10 of FIG. 1 taken at the sectioning plane and in the direction indicated by section lines 2-2. Situated between the end portions 16 and 18 are the central segments 20 and 25. The wall thickness, internal diameter, and external diameters of central sections 20 and 25 are larger than the end portions 16 and 18. The central segment 20, designated as the ventricle or ventricular segment of the tube has a wall thickness that can be greater than any of the other segments. Segment 20 is the segment upon which the pump rollers act to compress the tubing during the peristaltic pumping process. The central segment 25, designated the atrium or atrial segment, is located immediately proximal to the ventricular segment 20, and provides a fluid reservoir immediately adjacent to the intake portion of the ventricular segment.

The tube 10 is further formed with three intermediate segments 22, 23 and 24. Segment 22 lays between the arterial portion 16 and the ventricular portion 20. Segment 23 lays between the ventricular portion 20 and the atrial portion 25. Segment 24 lays between the atrial portion 25 and the venous portion 18.

These portions 22, 23 and 24 define the tapering zones of the tube 10 which gradually increases in diameter from the end portions 16 to the ventricle 20, from the ventricle 20 to the atrium 25 and from the venous segment 18 to the atrium 25. These tapered portions 22, 23 and 24 gradually increase in outside diameter in a direction toward the atrium 25. The degree of tapering is sufficiently gradual to minimize hemolysis as blood travels through the tube 10.

The tube 10 is formed with wall thickness varying along the transitional segments 22, 23 and 24; the wall thickness of each of the segments 16, 20, 25, and 18 differs, but within each individual segment the wall thickness remains substantially constant.

The tube 10 may be formed by any conventional method, but preferably is formed by extrusion. Extrusion techniques are well known with the puller rate, temperature of the polymer and the air pressure exerted inside the forming tube controlled to provide the above described tapering.

FIGS. 3A, 3B, 3C and 3D show sectional views of the tube in accordance with the tube is seen generally at 10 of FIG. 1 taken at the sectioning planes an in the direction indicated by section lines 3A-3A, 3B-3B, 3C-3C, and 3D-3D respectively. FIGS. 3A, 3B, 3C and 3D illustrate the outside diameter (OD), inside diameter (ID) and wall thickness (wall) of one example of the various embodiments of the distensible peristaltic pump tubing with atrium which can have the following dimensions:

In FIG. 3A, 16, the arterial segment OD is approximately 3.575 mm, ID is approximately 3.175 mm, and wall thickness is approximately 0.2 mm.

In FIG. 3B, 20, the ventricular segment OD is approximately 9.525 mm, ID is approximately 4.7625 mm, and wall thickness is approximately 2.4 mm.

In FIG. 3C, 25, the atrial segment OD is approximately 14 mm, ID is approximately 11 mm and wall thickness is approximately 1.5 mm.

In FIG. 3D, 18, the venous segment OD is approximately 3.775 mm, ID is approximately 3.175 mm and wall thickness is approximately 0.3 mm.

The approximate length of the tapered portion 22 is fourteen cm with the ventricular section 20 having a length of around 35 cm. The length of the end portions 16 and 18 may vary with respect to each other and from example to example. The approximate length of the atrial segment 25, including the tapered segments 23 and 24 is ten to twenty five cm.

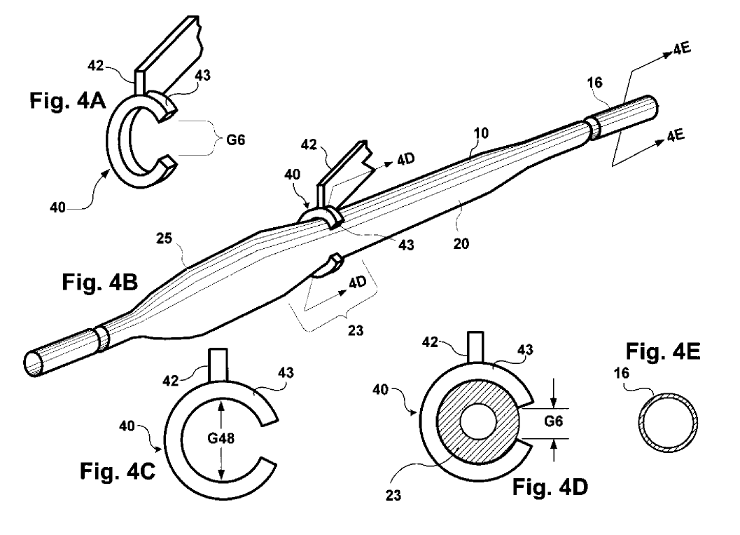

FIG. 4A is a partial perspective view of an embodiment of a tube-holder assembly 40 with a C-shaped tube-holder 43 and a support arm 42 for securing roller pump tubing within a peristaltic pump. Gap G6 is the distance between the two ends of the C-shaped tube holder 43.

FIG. 4B is a perspective view of tube 10 located within the C-shaped tube-holder assembly 40. The C-shaped tube-holder assembly 40 consists of support arm 42 attached to the C-shaped tube-holder 43. The roller pump tube 10 is inserted into the tube holder assembly 40 by first passing a portion of the narrow arterial segment 16 through the gap G6 of the C-shaped tube-holder 43 into the space within the inside circumference of the C-shaped tube holder 43. Next the tubing 10 is advanced through the C-shaped tube-holder so that the ventricular segment 20 passes through the C-shaped tube-holder and until the tapered segment 23 of tube 10 becomes snuggly wedged within the inside diameter of the C-shaped tube holder 43. The outside diameter of the tapered segment 23 between the ventricular 20 and the atrial 25 segments of tube 10 is larger than the inside diameter of the C-shaped tube holder 43, and thus the tube 10 is prevented from being pulled through a peristaltic pump by the vector force applied to the tubing as a result of the rotation of pump rollers. The atrial segment 25 and the venous segment 18 of tube 10 do not pass through the tube-holder 43.

FIG. 4C is a partial frontal view of the C-shaped tube holder assembly 40 and the support arm 42 illustrating the inside diameter G48 of the C-shaped tube-holder 43.

FIG. 4D is a sectional view of the tube 10 and the C-shaped tube-holder 43 taken at the sectioning plane and in the direction indicated by section lines 4D-4D, shown in FIG. 4B which is tangent to the frontal surface of 43. The C-shaped tube-holder assembly 40 consists of support arm 42 attached to the C-shaped tube-holder 43. Gap G6 is the distance between the two ends of the C-shaped tube holder 43.

FIG. 4E is a partial section view of 4B taken through the section lines 4E-4E through the arterial segment 16 of tube 10. Twice the wall thickness of the arterial segment 16 should be generally equal to or less than the gap G6 of FIG. 4D, and therefore arterial segment 16 can be squeezed and slipped through gap G6 and into the space bounded by the inner circumference of the C-shaped tube holder 43.

The C-shaped tube-holder has no moving parts and secures the tube in its proper position and prevents roller-induced migration of the tube.

The C-shaped tube-holder is attached to the pump housing. The OD of the atrial segment 25 may be larger than the ID of the C-shaped tube-holder. The gap in the C-shaped collar may be slightly larger than the outside diameter of the arterial segment of the tubing, and the inside diameter of the C-shaped collar may be slightly larger than the outside diameter of the ventricular segment, but significantly smaller than the outside diameter of the atrial segment. In order to engage the tubing in the C-shaped tube-holder, firstly the operator squeezes a portion of the arterial segment, slightly deforming the cross-section from an annular shape into an ovoid shape and then slips the tubing through the narrow gap in the C-shaped tube-holder; secondly, the arterial and ventricular segments of the tubing is pulled longitudinally through the C-shaped tube-holder until the large OD of the atrial segment is stopped at the narrower ID of the C-shaped tube-holder. The oversized OD of the atrial segment prevents the tubing from slipping through the narrower ID of the C-shaped tube-holder. This elegant solution to the problem of preventing tube-slippage reduces to one the number of pump-housing parts necessary to secure the tubing, thereby eliminating a complex and chronically trouble prone design element in traditional peristaltic roller pumps.

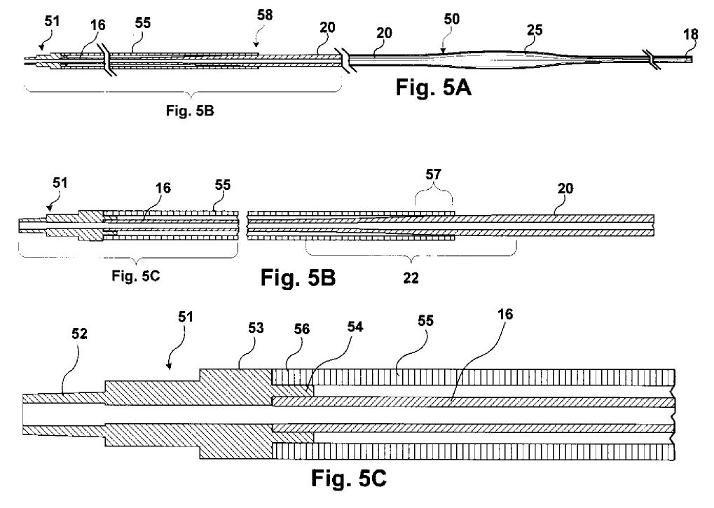

Tubing with two concentric arterial segments may reduce kinking of the tubing. A kink in a tube that transports blood is a recognized cause of hemolysis. Because of its lack of rigidity, the distensible, relatively thin wall of the arterial (outlet, distal) portion may have a tendency to kink under certain situations. One embodiment discussed herein overcomes this potential limitation by placing a second, more rigid tube concentrically outside the outlet tube segment, as shown in FIGS. 5A-C. These two concentric tubes have an empty space between them and they are attached only at the proximal and distal extremity of the outer tubing.

FIG. 5A is a partial sectional view of tube assembly 58 which consists of an assemblage of the peristaltic pump tube 50, exterior tube 55, and distal hub-connector 51. The distensible arterial segment 16 of tube 50 is covered by a longitudinally concentric exterior tube 55 that prevents kinking of the relatively soft distensible arterial segment. Tube 50 which is a peristaltic roller pump tube with atrium 25 and a distensible distal arterial segment 16, together with a central ventricular segment 20 and a proximal venous segment 18. The tube 50 is analogous to the tube 10 of FIG. 1A. In contrast to tube 10, tube 50 is covered by a longitudinally concentric exterior tube 55 that prevents kinking of the relatively soft distensible arterial segment 16. The exterior tube 55 is bonded to tube 50 along the proximal segment 57 of exterior tube 55. The distal end of 55 is bonded to the distal hub-connector 51.

FIG. 5B is an enlarged view of the distal portion of the tube assembly 58 shown in FIG. 5A. The distal arterial segment 16 of Tube 50 is interiorly concentric with the exterior tube 55, both of which are distally bonded to the distal hub-connector 51 and proximally bonded along segment 57 where exterior tube 55 comes into contact with the transition segment 22 of tube 50. The interior surface of the proximal portion 57 of the flexible kink-resistant tube 55 is bonded circumferentially to a localized portion of the tapered segment 22 of tube 50. Tube exterior tube 55 is relatively rigid compared to the relatively soft distensible arterial segment 16, and thus tube 55 prevents kinking of the soft distensible arterial segment 16.

FIG. 5C is an enlarged view of the distal portion of FIG. 5B providing a detailed view of the distal hub-connector 51 of tube assembly 58. The distal portion 52 of hub connector 51 may function as a standard slip Luer connector. The proximal portion of 54 is designed to accommodate the concentric attachment of both the distensible arterial segment 16 and the more rigid exterior tube 55. The mid portion 53 of the distal hub-connector 51 can be used as a finger grip by which the clinician holds the hub-connector 51 and directs the use of the roller tube assembly 58 during a clinical application. The bonding portion 54 of the hub-connector 51 is a radial symmetric about the long axis of the hub-connector. The exterior portion of 54 of hub-connector 51 provides a surface for bonding the distal portion 56 of tube 55 to the hub-connector 51. The interior surface of the distal portion 56 of the flexible kink-resistant tube 55 is bonded circumferentially to the exterior surface of 54. The interior portion of 54 provides a surface for bonding the exterior distal portion of the arterial segment 16 of tube 50 to the hub-connector 51. The flexible kink-resistant tube 55 is longitudinally concentric with and exterior to the arterial segment 16 of tube 50. Tube 55 is flexible but relatively stiff and can provide resistance to kinking of the soft distensible arterial portion or tube 50, while not inhibiting the distensible quality of tube segment 16.

Use of concentric outer support tubing is an alternative embodiment. The arterial tube segment has concentric outer tubing, made of more rigid PVC tubing. These two concentric tubes may have an empty space between them and may be attached only at the proximal and distal extremity of the outer tubing. There are at least three important applications for this embodiment.

First, the concentric outer tube can prevent kinking of the inner tube. A kink in a tube that transports blood is a recognized cause of hemolysis. Because of its lack of rigidity, the distensible relatively thin wall of the outlet (distal) portion may have a tendency to kink under certain situations. The rigidity of the outer tube makes it resistant to kinking. The more rigid outer tube thus provides an exoskeleton-like support for the thin-walled distensible inner tube

Second, the outer concentric tube can be modified to provide a dampening effect on the pulse pressure wave associated with the peristaltic wave pumping action. The distensibility of the inner tube already provides some dampening of the pulsatile flow of fluid. Additional dampening can be achieved by filling the empty space between the two tubes with a non-compressible liquid or a compressible inert gas. Maximal dampening is a desirable feature for clinical applications such as extracorporeal blood pumping and flushing body cavities with steady non-pulsatile stream of sterile physiologic saline during endoscopic surgical procedures.

Third, the concentric tubes can be modified to allow circulation of heated sterile liquid, such as sterile saline, through the space between the two tubes and thereby act as a fluid-warming device.

Tubing having two atrial segments, one immediately adjacent to either end of a single ventricular segment, is useful in a number of situations. In a situation where distensible arterial tubing lacks sufficient rigidity and is too prone to kinking, it may be desirable to have stiffer arterial tubing; in this situation the distal atrial segment may provide sufficient distensibility to result in a significant overall reduction of hemolysis. Another advantage is that two atrial segments permit the pump housing to have two C-shaped tubing holders to secure the tubing as it enters the roller-compression raceway and to secure it as it exits the raceway.

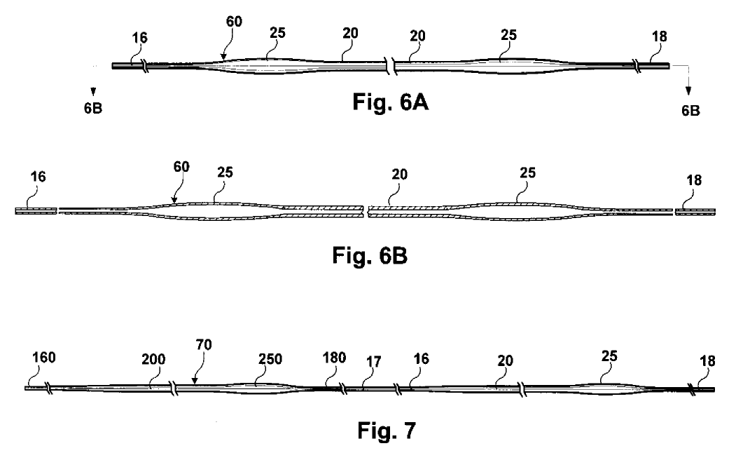

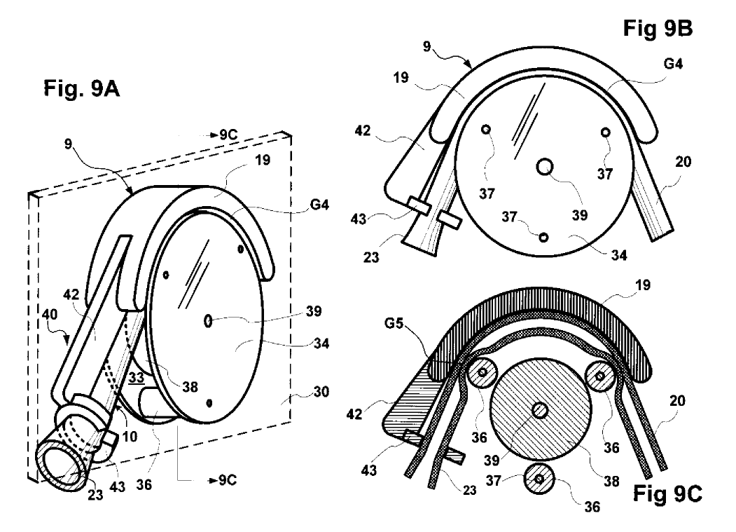

FIG. 6A shows a peristaltic roller pump tube 60 which is an alternate embodiment of an extruded roller pump tubing having two central atrial segments 25 separated by a single ventricular segment 20, together with a proximal venous segment 18 and a distal arterial segment 16. This embodiment is useful for tumescent infiltration of tumescent drugs where it is advantageous to have a peristaltic roller pump that can function as both a pump and an aspirator merely by reversing the direction of rotation of the roller pump assembly. The combination of the two atria prevents the tube from migrating through peristaltic pump in the direction of a vector force applied to the tube by the rotation of the roller assembly. A peristaltic roller pump tube of type 60 requires a roller pump assembly 31 shown in FIG. 9A where the gap G4 is slightly larger than twice the wall thickness of the ventricular tube segment 20. A roller pump shown in FIG. 9A with a gap G4 that is slightly larger than twice the wall thickness of the ventricular tube segment 20 permits the longitudinal insertion of the ventricular segment 20 through gap G4 by manually compressing a portion of segment 20 and then squeezing this portion of segment 20 through gap G4.

FIG. 6B shows a sectional prospective view of the tube 60 shown in FIG. 6A taken at the sectioning plane and in the direction indicated by section lines 6B-6B. Tube 60 consists of distal arterial segment 16, a proximal venous segment 18 and two atrial segments 25 separated by a ventricular segment 20.

Tubing for two or more peristaltic pumps in series has potential clinical applications. For critical applications, having a second stand-by pump provides an extra degree of confidence in the ability to withstand a failure of the first pump. For example, while the first pump is providing the peristaltic pumping function, the rollers of the second pump remain in a retracted position away from the tubing; but in the event that first pump fails, immediately the rollers of the first pump can be retracted and the second pump can actuated and the rollers of the second pump can be extended into full contact and engagement with the pump tubing; in this manner there is virtually no interruption of the peristaltic pump function. Another clinical application can arise where it is desirable to have two peristaltic pumps acting in concert on the same tubing. For example, two pumps acting in concert on one tube can provide the same rate of fluid flow as a single pump, however the pressure generated by each of two pumps would individually be less that that generated by the single pump. In a situation where hemolysis is a non-linear or non-additive function of pump pressure, a two-pump or multi-pump arrangement can reduce the degree of hemolysis for a given rate of fluid flow.

FIG. 7 shows an alternate embodiment 70 of an extruded roller pump tube having two tube sub-segments in series, wherein each of the two segments is similar to tube 10 in FIG. 1. This embodiment is useful when there is a need two peristaltic pumps in series. Tube 70 consists of a proximal first venous segment 18, a first atrial segment 25, a first ventricular segment 20, a first arterial segment 16, a transition segment 17, a distal second venous segment 180, a second atrial segment 250, a second ventricular segment 200 and a second arterial segment 160.

Fluted or rifled tubing having a scalloped cross-section is another embodiment. The simplest embodiment has a circular cross-section along its entire length including the distensible arterial segment. In another embodiment the arterial segment of the tubing can have a longitudinally fluted wall with long straight fluting with an approximately circular cross-section. This geometric pattern with fluting provides a longitudinal pleated-effect which increases the distensibility of the tubing.

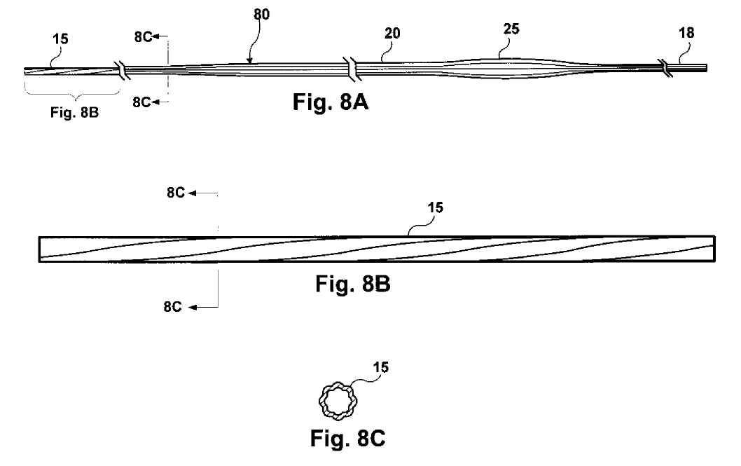

In another embodiment the longitudinal fluting of a segment of tubing can assume a helical geometry or have helical revolutions about a cylindrical segment of tubing. See FIGS. 8A, 8B, and 8C. Helical fluting has applications were turbulent fluid flow is desirable, and therefore helical fluting might not be desirable for extracorporeal circulation of blood where turbulent flow increases hemolysis. A helical pattern has the same cross section as a segment of straight or linearly fluted tubing. The inside surface of a helically fluted segment of tubing can resemble the rifling of a gun barrel with grooves along the bore of the barrel. The practical effect of the rifled tubing is that the fluid flowing along the tubing is subjected to a significant turbulence which enhances fluid mixing. The turbulent flow associated with helical fluting can also cause friction between the fluid and the luminal wall of the tubing, thereby increasing the temperature of the fluid. Helical rifling has applications for the subcutaneous infiltration of large volume of tumescent fluid where it is desirable for the tumescent fluid to be warmed above room temperature, thereby reducing the incidence of hypothermia.

FIG. 8A shows an alternate embodiment of extruded roller pump tubing 10 which consists of tube segments analogous to those of tube 10 of FIG. 1, wherein the venous segment 18, the atrial segment 25 and the ventricular segment 20 are identical to the corresponding parts of the tube 10. The arterial segment 15 is analogous to arterial segment 16 of tube 10 of FIG. 1, but in contrast to segment 16 of tube 10, the arterial segment 15 has longitudinal fluted grooves which may be either parallel to the long axis of the tube or the segment 15 may have a helical fluted pattern as shown in FIGS. 8A and 8B. The fluted design allows for increased distensibility of the segment 15. The helically fluted arterial segment 15 produces increased mixing of the fluid being pumped through the tube 80. Also the helically fluted arterial segment 15 causes increased turbulence and friction between the tubing and the fluid which can produce a degree of heating of the fluid being pumped through the tube 80, which is beneficial when the tubing is used for infiltration of tumescent local anesthesia.

FIG. 8B shows an enlarged view of the fluted distal arterial segment 15 wherein the fluted pattern is helical.

FIG. 8C shows a sectional view of FIG. 8B taken through the section lines 8C-8C. The internal or luminal surface of the helically fluted segment has a surface that resembles the grooves or rifling of a gun barrel.

Tubing sets that have equal cross-sectional area may have cross-sections that are circular or non-circular. Non-circular cross-sections have a greater circumference than a circle, and thus will be more easily dilated by increases in intraluminal pressure and thereby dampen the cyclic pulse pressures that are typical of peristaltic roller pumps and thus improve laminar flow. For cardiac by-pass surgery this will allow more gentle and continuous flow of oxygenated blood as it returns to the patient, thereby decreasing trauma to the red blood cell wall membrane and thus decrease hemolysis. A scalloped circumference imparts a fluted appearance externally. See FIG. 3E. The fluting can be continuously parallel to the long axis of the tube or it may have a helical pattern that longitudinally winds around the long axis at shallow angle of pitch. This pitch may change as a function of the linear distance along the tube's long-axis. Tubing having a scalloped cross-sectional circumference with a shallow longitudinal helical progression can improve the laminar qualities of the fluid flow within the tubing.

FIG. 9A is a perspective view of the roller pump assembly 9 herein illustrated with a segment of the tube 10 in the raceway. FIG. 9A illustrates one embodiment C-shaped tube-holder 40 which is attached to the raceway 19. Roller pumps are generally well known in the art. The pump head assembly 9 shown in FIG. 9A may have the C-shaped tube-holder which eliminates the need for more complex multiple component clamp devices that are required to prevent the tube 10 from slipping or migrating through the pump raceway in the direction of the rotation of the roller assembly as a result of the force vector applied to the tubing by the rotation of the pump rollers. The transitional segment 23 (see FIGS. 2 and 4B) of tube 10 has an outside diameter that is larger than the inside diameter of the C-shaped tube-holder 43.

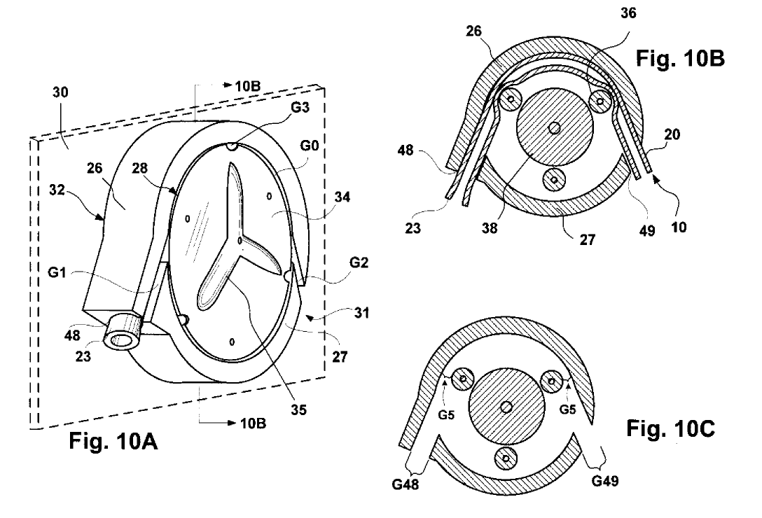

Another aspect is the method of inserting the tube 10 into the peristaltic pump assembly 9. The first step in this tube insertion process may be inserting the distal portion of the arterial segment 16 through the C-shaped tube-holder 43, then pulling a length of the arterial segment 16 through 43 and past the exterior surface of the anterior wall of the roller assembly spool 34. Next, an appropriate length of the arterial segment 16 is slipped or squeezed lengthwise through the gap G4 between the superior rim of the anterior wall 34 of the roller assembly spool and the inferior rim of the roller raceway 19. When the length of the arterial segment 16 of tube 10 is within the space between the raceway 19 and the rollers 36, the operator grasps the tube distally and gently pulls the tube in a direction that lies within a plane between and parallel with the two walls 33 and 34 of the roller assembly spool, while at the same time actuating the peristaltic pump motor at a relatively slow rotational speed. In this way the tubing is gradually fed into the pump until the ventricular segment has entered between the rollers and the raceway within the roller pump housing and the outside circumference of the tapered transitional segment 23, located between the ventricular segment 20 and the atrial segment 25 of the tube 10, becomes snuggly engaged within the inside circumference of the tube-holder 43. At this point the tube is fully inserted and engaged within the pump and operationally ready to begin the process of peristaltic pumping. The embodiment shown in FIG. 9 illustrates the innovative interaction between the C-shaped tube-holder 43 and the transitional segment 23 of the atrial segment 25 of tube 10; the need for complex multi-component tube clamps and flange-coupling devices upon which the prior-art pumps have relied in order to secure the pump tubing in a fixed position relative to the rollers and prevent the tubing from migrating through the pump housing is eliminated. Prior-art clamps and flange-coupling devices may be replaced with a simple one-part C-shaped aperture in the roller pump housing that involves no moving parts. Other embodiments of the pump head assembly such as the more advanced embodiment of the pump head assembly 31 are illustrated in FIGS. 10A, 11, 12, and 13 and are described below in the corresponding paragraphs.

FIG. 9B is a frontal prospective view of FIG. 9A showing the roller pump assembly 9, roller raceway 19, the ventricular segment 20 and the transitional segment 23 of the peristaltic pump tube, the roller axels 37 and the axel of the roller assembly spool 39, the anterior wall of the roller assembly spool 34, the C-shaped tube-holder 43 and the support arm 42, and the arcuate gap G4 between 34 and 19.

FIG. 9C is a sectional view of FIG. 9A through the section lines 9C-9C showing the roller pump assembly 9, roller raceway 19, the ventricular segment 20 and the transitional segment 23 of the peristaltic pump tube, the rollers 36, the roller axels 37, the arbor of the roller spool, and the roller assembly spool 39, the anterior wall of the roller assembly spool 34, the C-shaped tube-holder 43 and the support arm 42, and the gap G5 which is the space between the rollers 36 and the raceway 19 containing the compressed tube 20.

FIG. 10A shows an embodiment of the roller pump head assembly 31. Generally, the roller pump head assembly 31 includes a ring-shaped housing formed with an approximate circular wall 32, and a roller assembly 28. Together roller-raceway 26 and the roller-guard 27 make up the circular housing 32. The roller pump raceway 26 and the roller-guard 27 are sub-segments of the circular housing 32. The circular housing 32, including the roller-raceway 26, and the roller-guard 27, is attached to the wall of the motor housing 30. The roller-guard 27 isolates the rollers within the roller pump head assembly 28 and prevents entanglement of clothing, hair or fingers within the roller pump head assembly 28. The tube-holder 48, preferably C-shaped, provides a method for securing the roller pump tubing 10 within the pump head assembly 31.

Gaps G1 and G2 are larger than twice the wall thickness of the arterial segment 16 and permit the operator to push a segment of the arterial segment through G1 and G2 and into the C-shaped passageways 48 and 49. Gap G0 is the gap between circular raceway 32 and the anterior spool wall 34. The gap G0 is smaller than one wall thickness of the arterial segment 16. Thus gap G0 is so small that no segment of a roller pump tube 10 can be squeezed through G0. The gaps G3 are identical semicircular openings along the circumference of the anterior wall 34 of the roller assembly spool. Gaps G3 are an essential component in the innovative method for inserting the roller pump tubing 10 into the roller pump assembly 31. The finger-grip 35, a part of the anterior wall 34, is a raised area on the surface of the anterior wall of the spool 34 by which one can turn the roller assembly 28 during the process of loading tube 10 into peristaltic pump assembly 31.

The tube holder 48 is integrally incorporated into the ring-shaped circular wall 32 between the pump head raceway 26 and the roller guard 27. In particular, the pump head raceway 26 and the roller guard 27 may have inner surfaces which has the same configuration and mates with the outer surface of tapered segment 23. For example, the inner surfaces of the pump head raceway 26 and the roller guard 27 may have semi circular configurations. The continuous rotation of the roller assembly 28 exerts a vector force that acts on the ventricular segment 20 of tube 10 and tends to force the tubing through the roller raceway. A certain portion of the tapered segment 23 has an OD which is equal to the ID G48 of the tube holder 48. The inside diameter G48 of the tube-holder 48 is smaller than the outside diameter of a portion of segment 23 of tube 10. The tube-holder engages the tapered segment 23 which becomes wedged into the tube-holder 48 where it is held snuggly and prevented from moving through the pump housing 31.

FIG. 10B is a sectional view of FIG. 10A taken at the section lines 10B-10B. Tapered tube segment 23 of tube 10 is shown engaged within the C-shaped tube-holder 48 and the rollers 36 compress a portion of the ventricular segment 20 against the raceway 26. The ventricular segment 20 exits the roller pump head assembly through the passageway 49, preferably having a C-shape. The roller spool arbor 38 provides structural stability to the roller assembly 28. The roller guard 27 protects the roller assembly 28. The individual rollers 36 press radially outward against the tube 10 as the roller assembly 28 rotates within the concave surface of the raceway 26. The tube 10 is dimensioned to be positioned so that substantially only the ventricular section 20 is positioned between raceway 26 and the roller assembly 28 during the pumping action. The actual length of the central section 20 is critical to allow for the appropriate positioning of this section within the roller raceway 26.

FIG. 10C is similar to FIG. 10B, however the tube 10 has been removed to allow a clearer demonstration of the precise locations of the gaps G5, G48 and G49.

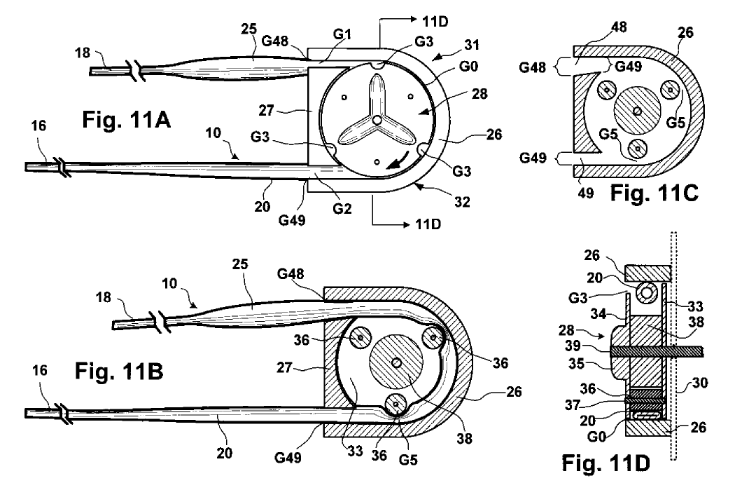

FIG. 11A is a frontal view with peristaltic tube 10 operationally engaged within the peristaltic pump head assembly 31. The peristaltic pump head assembly 31 consists of the roller assembly 28 and the roller housing 32. The roller housing 32 consists of the roller raceway 26 and the roller-guard 27. The roller assembly consists of the anterior wall of the roller spool 34 as well as the posterior wall of the roller spool and spool arbor which are not visible in FIG. 11A. The peristaltic tubing 10 consists of an arterial segment 16, ventricular segment 20, atrial segment 25, transitional segment 23 between 20 and 25 and venous segment 18. Gap G0 is the gap between circular raceway 32 and the anterior spool wall 34. Gap G3 is a gap along the edge of anterior wall 34 of the spool. Gap G1, G2 are gaps through which tube 10 is inserted into the pump head assembly. The gap G48 holds tube 10 in a stable fixed position and G49 is the tube-passage way for the tube 10 to exit the pump head assembly.

FIG. 11B is a partial sectional view of FIG. 11A showing parts of the roller assembly not visible in FIG. 11A, including the rollers 36, the posterior wall of the roller spool 33 and spool arbor 38. Also shown are roller raceway 26 and the roller-guard 27, the gap G5 between the roller 36 and the roller raceway 26 and the gaps G48 and G49. The peristaltic tubing 10 consists of an arterial segment 16, ventricular segment 20, atrial segment 25, transitional segment 23 between 20 and 25 and venous segment 18.

FIG. 11C is a section view of FIG. 11B without the peristaltic pump tube 10 and without the posterior wall of the roller spool. The location of the gaps G5, which represents the gap between a roller 36 and the roller raceway 26, are shown. The tube passageway 49 has an inside diameter dimension G49, which is larger than the outside diameter of ventricular segment 20 of tube 10. The C-shaped tube-holder 48 has an inside diameter G48 which is larger than the outside diameter of the ventricular segment 20 of tube 10 but much smaller than the outside diameter of the atrial segment 25 of tube 10. The C-shaped tube-holder can have a tapered longitudinal cross section, in which case the smallest inside diameter can have the same dimension as G49.

FIG. 11D is a sectional view taken at section lines 11D-11D of FIG. 11A. The roller spool assembly 28 consists of the roller(s) 36 is with roller axel 37 which is attached to both the anterior roller spool wall 34, with its integral finger-grip 35, and the posterior roller spool wall 33 which in turn are supported by the roller assembly axel 39 and the roller assembly arbor 38. The roller raceway 26 is shown attached to the anterior wall of the motor housing 30. The ventricular segment 20 of the peristaltic pump tubing is shown in two sections. The lower section shows 20 compressed between roller 36 and the roller raceway 26, while the upper section shows 20 not compressed. Gaps G0 and G3 are smaller than twice the wall thickness of 20 and therefore there is no possibility that 20 can exit the pump head assembly through G0 or G3.

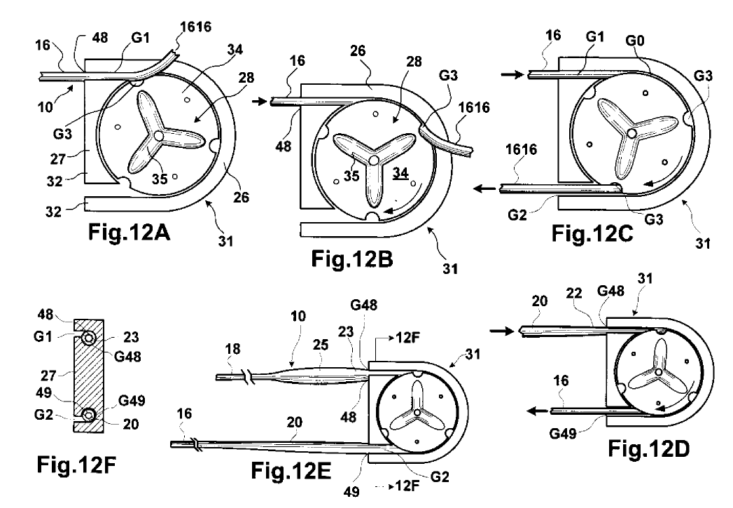

FIGS. 12A, 12B, 12C, 12D, and 12E are prospective frontal views of the roller pump head assembly 31 together with portions of the distensible peristaltic pump tubing with atrium 10 illustrating the method of inserting the tubing into the roller pump.

The distensible peristaltic pump tubing with atrium 10 consists of several distinct segments including the distal arterial segment 16, the ventricular segment 20, the atrial segment 25, and the venous segment 18. The important transitional segment 23 may be located between segments 20 and 25.

The parts of the peristaltic pump head assembly 31 which are important to the method of loading the tube 10 into the pump assembly 31 include the roller raceway 26, the roller-guard 27 which together make up the roller housing 32 and the roller assembly 28. The ring-shaped housing 32 consists of the roller raceway 26, the roller-guard 27, the C-shaped tube-holder 48, and the C-shaped tube passageway 49. The finger-grip 35 is raised area on the surface of the anterior wall of the spool 34 by which one can turn the roller assembly 28 during the process of loading tube 10 into peristaltic pump head assembly 31.

Important spaces or gaps within the pump assembly 31 include the gaps G0, G1, G2, G3, G5, G48 and G49. The symbols G0, G1, G2, G3, G5, G48 and G49 also refer to the magnitude of the linear dimensional measurement of the respective gaps.

Gap G0 is the space between circular raceway 32 and the anterior spool wall 34. It is desirable that gap G0 is as small as possible in order to minimize the risk of clothing or fingers becoming entangled in the roller assembly, and to minimize tube falling out of the pump head assembly.

G1 is the longitudinal gap within the anterior surface of the circular housing 32 of the roller pump head assembly 31 through which a short loop of the arterial segment 16 of tube 10 is inserted into the C-shaped tube-holder 48 during the initial phase of the process of placing the ventricular segment 20 into the roller raceway and into the gap G5 between the raceway 26 and the rollers 36. Also, during the process of removing the tube 10 from the roller pump head assembly 31 a portion of the arterial segment 16 is pulled out from the C-shaped tube-holder 48 and through gap G1. In one embodiment Gap G1 is no larger than the outside diameter of arterial segment 16 of tube 10. Thus Gap G1 is significantly smaller than gap G48 where G48 is larger than the outside diameter of ventricular segment 20 of tube 10.

G2 is the longitudinal gap in the anterior surface of the circular housing 32 of the roller pump head assembly 31 that permits the insertion of arterial segment 16 of tube 10 into the C-shaped tube-passageway 49 during the process of placing the ventricular segment into the roller raceway 26. Also, during the process of removing the tube 10 from the roller pump head assembly 31 a portion of the arterial segment 16 is pulled out from the C-shaped tube-passageway 49 and through gap G2.

G3 is a semicircular opening or notch along the circumference of the anterior wall 34 of the roller assembly spool. There can be one gap G3 or multiple similar gaps G3 on 34. Gap G3 is an essential component in the innovative method for inserting the roller pump tubing 10 into the roller pump assembly 31.

G5 is the gap between a roller 36 and the concave surface of the inner circumference of the roller raceway 26. As a general rule, the distance G5 should be approximately equal to twice the wall thickness of the ventricular segment 20 of the tube 10 (FIGS. 11B and 11C).

G48 is the inside diameter of the C-shaped tube holder 48. G48 is slightly greater than the outside diameter of the ventricular segment 20 of tube 10, and G48 is significantly smaller than the outside diameter of the atrial segment 25 of tube 10. In one embodiment a distal portion of the transitional segment 23 of tube 10 becomes snuggly wedged into 48 which holds the ventricular segment 20 stationary within the roller raceway 26 and prevents the tube 10 from being forced through the peristaltic pump head assembly 31 by the vector force of the rotating roller assembly 28.

G49 is the inside diameter of the tube-passageway 49. G49 can be greater than the outside diameter of ventricular segment 20 of tube 10 and G49 can be greater than the outside diameter of arterial segment 16 of tube 10.

The method of inserting tube 10 into the peristaltic pump head assembly 31 includes the following steps. FIG. 12A depicts the initial step in the process of inserting tube 10 into peristaltic pump head assembly 31. FIG. 12A is a frontal view showing a portion of arterial segment 16 of tube 10 inserted lengthwise into the longitudinal gap G1 of the ring shaped roller housing 32 and exiting out of gap G3 in the roller spool wall 34. The outside diameter of 16 can be approximately the dimension of gap G1. In the process of inserting tube segment 16 into pump head assembly 31, a length of arterial segment 16 positioned so that it is approximately parallel to gap G1, that portion of segment 16 is then push lengthwise through gap G1 and into the C-shaped tube-holder represented by gap G48. At the completion of this initial step, a short portion of arterial segment 16 enters the pump head assembly 31 at the gap G48 and exits through the roller spool wall 34 at gap G3. The more distal portion of arterial segment 1616 does not enter through gap G1 or gap 48. In some medical applications, the most distal portion of 1616 can remain sterile while the most proximal portions of 1616 come into contact with the non-sterile pump head assembly 31 during the process of inserting the tube 10 into the pump 31.

FIG. 12B is a frontal view during the second step in the process of inserting arterial segment 16 of tube 10 into the pump head assembly 31. The portion of the arterial segment 16 that has been placed within gap G3 remains fixed in position relative to its location within gap G3. While maintaining the portion of 16 located within gap G3 fixed within G3, the finger-grip 35 is manually rotated in order to turn the roller spool wall 34 in the direction of the arcuate arrow. As the spool wall 34 turns with the tube 10 held fixed relative to gap G3, the trailing portion of segment 16 is pulled in through the C-shaped tube-holder 48, as indicated by the dark arrow, and into the gap between the rollers of roller assembly 28 and the roller raceway 26 of the roller pump assembly 31. See FIG. 11C. Any portion of segment 16 that is within the roller raceway cannot be unintentionally removed from its location and cannot accidentally “fall out” of the pump head assembly 31 because gap G0 between the spool wall 34 and the raceway 26 is too small to permit the passage of tube segment 16. The distal portion of arterial segment 1616 remains exterior to spool wall 34 and rotates with the gap G3.

FIG. 12C is a frontal view during the third step in the process of inserting arterial segment 16 of tube 10 into the pump head assembly 31. As the finger-grip 35 on spool wall 34 continues to be manually rotated in a clockwise direction, more and more of the arterial segment 16 is drawn into the roller pump head. With the continued rotation of the spool wall 34 the gap G3 and the arterial segment 16 contained within G3 eventually come into alignment with gap G2. At the point where the gap G3 is aligned with gap G2, a length of arterial segment 1616 is pushed or squeezed into the gap G2 until 1616 enters into the more posterior tube-passageway which is parallel to G2. The relative positions of G1 to G48 and G2 to G49 are shown in FIG. 12F. At this point, the process of inserting the arterial segment 16 of tube 10 into the peristaltic pump head assembly is complete. There are two additional steps that remain to be completed in order for the ventricular segment 20 and the atrial segment 25 to be well positioned within the roller pump assembly 31 and ready for peristaltic pumping action to commence.

FIG. 12D is a frontal view during the fourth stage in the process of inserting the peristaltic tube 10 into the peristaltic pump head assembly 31. With the pump motor actuated at a relatively slow rotational velocity in the direction of the arcuate arrow, a gentle traction is manually applied to the arterial segment 16 as it exits the tube-passageway G49. In this fashion, first the transitional segment 22 and then the ventricular segment 20 enter through gap G48 into the roller pump head assembly 31 and then begin to exit through G49 as indicated by the dark arrows. Eventually the transitional segment 23 advances toward G48 where a portion of the relatively large outside diameter of 23 becomes snuggly wedged into the relatively smaller inside diameter of G48. The final result is depicted in FIG. 12E.

FIG. 12 E is a frontal view after the peristaltic tube 10 has been completely installed within the peristaltic pump head assembly 31 by means of the method described above for FIGS. 12A, 12B, 12C and 12D. The transitional segment 23 of the atrial segment 25 is snuggly wedged into the gap G48 associated with the C-shaped tube-holder 48. The combination of the peristaltic pump tubing 10 and the peristaltic pump head assembly 31 is ready to function as a peristaltic pump.

FIG. 12F is a sectional view of FIG. 12E taken at the section lines 12F-12F showing the C-shaped tube-holder 48 with a gap having inside diameter dimension G48 which is smaller than the outside diameter of the transitional segment 23, and the tube-passageway 49 with gap having inside dimension G49 which is larger than the outside diameter of the ventricular segment 20 of the peristaltic pump tube. Roller guard 27 is shown with gaps G1 and G2 both of which are narrower than twice the wall thickness of either tube segments 20 or 23, and therefore the tubing cannot exit through G1 or G2.

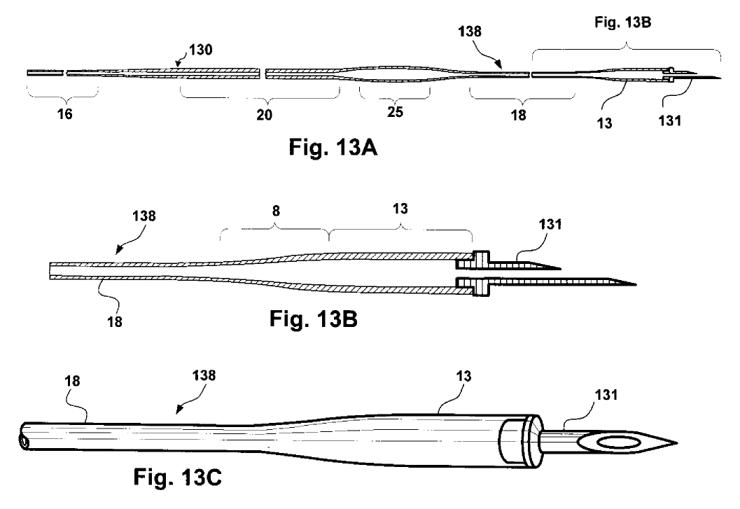

FIG. 13A is a cross-sectional view of the tube assembly 138 which may comprise tube assemblage of the peristaltic roller pump tube 130 and proximal IV-bag-spike 131. Tube 130 may be similar to tube 10 of FIG. 2 and may have a distal arterial segment 16, a central ventricular segment 20, a central atrial segment 25 and a proximal venous segment 18. In contrast to tube 10, tube 130 may have an optional drip chamber 13 which may be formed during the process of tube extrusion.

FIG. 13B is an enlarged view of the proximal portion of the tube assembly 138 shown in FIG. 13A. The venous segment 18 and the drip-chamber segment 13 can be concentric with central lumen of the IV-bag spike 131. After the IV-bag-spike is inserted into the bag of IV fluid (not shown), the inner lumen of the venous segment 18, the inner lumen of the drip chamber 13 and the inner lumen of the IV-bag-spike are in fluid communication with the IV bag fluid. A drip chamber is not a necessary component of the tubing. The drip chamber can provide visual confirmation that fluid is indeed flowing or dripping through the tube 130. After insertion of the IV-bag-spike into an IV bag, a drip chamber may hang below the IV bag and can be oriented such that long axis of the drip chamber is approximately vertical. The interior lumen of the drip chamber can contain a volume of air located between the lumen of the venous section 18 and the lumen of the IV-bag-spike. The drip chamber 13 of the tube 130 can have an inside diameter, an outside diameter and a wall thickness which are larger than corresponding dimensions of the immediately distal venous segment 18. Between the drip chamber 13 and the distal venous segment 18 of the tube 130, there may be a transitional segment 8 of tube 130.

FIG. 13C is a prospective view of proximal end of the assemblage 138 showing the IV-bag-spike 131, the drip chamber 13 and the venous segment 18.

The tubing discussed above may eliminate two of the three component parts of the prior art drip chambers. The dilated proximal end 13 of the extruded peristaltic roller pump tubing 130 eliminates the need for the combination of the clear plastic cylindrical tube and the distal cap that is attached to standard IV tubing.

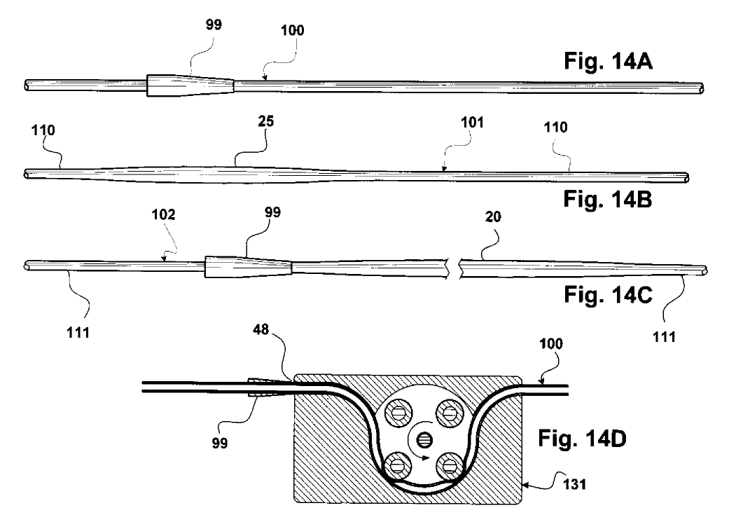

FIG. 14A is partial perspective view of infiltration tubing set 100 that can be used together with the present peristaltic pump head assembly such as the assembly shown in FIG. 11. The peristaltic pump tubing shown in FIG. 1, can have venous, atrial, ventricular, and arterial segments. The tubing shown in FIG. 1 has inside and outside diameters that can vary along the length of the tubing. Other tubing designs may be preferred for certain applications. One alternative design, shown in FIG. 14A, may have a uniform inside diameter, outside diameter, and constant wall-thickness together with a concentric shim 99 which is bonded or glued in place. The shim 99 can have a conical shape as shown in FIG. 14A, or any other shape that engages the C-shaped tube holder and prevents the migration of the tubing through the pump head assembly. One of the purposes of the concentric shim 99 is to engage the pump's C-shaped tube holder thereby holding the tubing securely and preventing the tubing from being pulled through the pumphead assembly by the traction of the rollers.

FIG. 14B is a partial prospective view of tube 101, and is yet another alternative design for a tubing set that can be used in concert with the peristaltic pump head assembly such as the assembly shown in FIG. 11. This tube is extruded with a discreet atrial segment 25 which is intended to engage the pump's C-shaped tube holder, and thereby hold the tubing securely and prevent the tubing from being pulled through the pump head assembly by the traction of the rollers. The outside diameter of the atrial segment 25 may be greater than the outside diameters of the ventricular segment and the venous segment. In this manner, the tubing is not pulled through the pumphead assembly by the traction of the rollers. Exclusive of segment 25, the remainder of the tubing can have inside diameter, outside diameter and wall thickness with uniform dimensions 110. Alternatively these dimensions may vary along certain segments as desired.

FIG. 14C is a partial prospective view of peristaltic pump tubing set 102 designed to function with the peristaltic pump head assembly such as the assembly shown in FIG. 11. Tubing 102 is yet another example of peristaltic pump tubing set with shim 99. The shim 99 can have a conical concentric shape, or any other shape that engages the C-shaped tube holder and prevents the migration of the tubing through the pump head assembly. Tube 102 can have a discreet ventricular segment 20 upon which the rollers of the peristaltic pump head assembly compress the tubing during the process of peristaltic pumping action. Exclusive of segment 20, the remainder of the tubing can have inside diameter, outside diameter and wall thickness with uniform dimensions 111. Alternatively these dimensions may vary along certain segments as desired.

FIG. 14D is a cross-sectional view of peristaltic pump head assembly 131 together with a peristaltic tubing set 100 having a shim 99 engaged in the C-shaped tube holder 48.

In relation to FIGS. 14A-D, it is contemplated that the inside diameters of the atrial, venous and ventricular segments may be uniform or equal to each other. The reason is that in certain applications, the peristaltic roller pump tubing functions more efficiently when the inside diameters of the atrial, venous and ventricular segments are uniform. Accordingly, the tubings discussed in relation to FIGS. 14A-D beneficially have a uniform inside diameter through the atrial, venous and ventricular segments. Also, the tubing does not migrate through the pump head assembly by the traction of the rollers due to the enlarged outside diameter of the atrial segment or shim 99.

While the preferred embodiments have been described, various modifications and substitutions may be made thereto without departing from the scope of the invention. Accordingly, it is to be understood that the invention has been described by way of illustration and not limitation.

What is claimed is:

1. A pump assembly comprising:
a flexible tube having a first segment and a second segment, the first segment having an outer diameter greater than an outer diameter of the second segment;
a peristaltic pump defining a passageway and having a tube holder, the tube holder having an aperture with an inner diameter smaller than the outer diameter of the first segment but larger than the outer diameter of the second segment, the first segment being disposed upstream of the tube holder, the second segment of the tube being disposed downstream of the tube holder in the passageway.

2. The assembly of claim 1 wherein the tube holder is integrated into a housing of the pump.

3. The assembly of claim 2 wherein the outer diameter, inner diameter, and wall thickness of the segments are consistent within at least two of the segments, and wherein the outer diameter, inner diameter, and wall thickness of the segments may vary in at least two of the segments.

4. The assembly of claim 1 further including a transitional segment between at least one pair of an arterial segment, a ventricular segment, an atrial segment, and a venous segment, the transitional segment having continuously varying outer diameter, inner diameter, and wall thickness.

5. The assembly of claim 1 wherein the tube holder has a C shape.

6. The assembly of claim 1 wherein the tube holder snugly fits the first segment to prevent the tube from migrating through the pump.

7. The assembly of claim 1 wherein inside diameters of the first and second segments are equal to each other.

8. A tube for a peristaltic pump, the tube comprising:
an arterial segment disposable downstream to a raceway of the pump;
a ventricular segment in fluid communication with the arterial segment, the ventricular segment disposable within a raceway of the pump, the ventricular segment defining an outer diameter;
an atrial segment in fluid communication with the ventricular segment, the atrial segment disposable upstream to the raceway of the pump, the atrial segment defining an outer diameter larger than the outer diameter of the ventricular segment; and
a venous segment in fluid communication with the atrial segment.

9. The tube of claim 8 wherein an inner diameter of the atrial segment is larger than an inner diameters of the arterial segment and venous segment.

10. The tube of claim 8 wherein inside diameters of the arterial segment, ventricular segment, and atrial segment are equal to each other.

11. A tube for a pump, the tube comprising:
a distensible arterial segment disposable downstream to an outlet of a raceway of the pump;
a ventricular segment in fluid communication with the arterial segment, the ventricular segment disposable within the raceway of the pump; and
a venous segment in fluid communication with the ventricular segment.

12. The tube of claim 11 wherein the arterial segment comprises:
an inner distensible arterial segment; and
an outer concentric segment disposed over the inner segment, the outer segment being relatively resistant to kinking.

13. The tube of claim 11 wherein the arterial segment has a rectilinear configuration.

14. The tube of claim 11 wherein the arterial segment has a fluted configuration.

15. The tube of claim 13 wherein the flutes have a helical configuration.

16. The tube of claim 11 wherein the venous segment includes a proximal venous segment having an enlarged outer diameter and an enlarged inner diameter, the proximal venous segment to function as a drip chamber for an intravenous tubing set.

17. A peristaltic pump having at least a C-shaped tube-holder and a roller pump head assembly.

18. The peristaltic pump of claim 17 having a narrow linear gap between the C-shaped tube-holder and the roller pump head assembly, the gap providing an entrance through which a portion of the arterial segment of the tube passable into or out of the C-shaped tube-holder.

19. The peristaltic pump of claim 17 wherein the roller pump head assembly further includes a C-shaped tube-passageway therein.

20. The peristaltic pump of claim 19 having a narrow linear gap between the C-shaped tube-holder and the roller pump head assembly, the gap providing an entrance through which a portion of the arterial segment of the tube can be passed into the C-shaped tube passageway.

21. The peristaltic pump of claim 17 wherein a roller spool wall of the pump includes notches located along the circumference of the spool wall through which a segment of the tube of claim 4 can be passed in order to insert the tube within the pump head assembly.

22. The peristaltic pump of claim 21 further including a finger grip on the notched spool wall.

23. A tube for a peristaltic pump, the pump defining a raceway and an upstream aperture, the tube comprising:
a ventricular segment disposable within the raceway during operation, the ventricular segment defining an inner diameter;
an atrial segment disposable outside of a housing of the pump and upstream of the raceway, the atrial segment defining an inner diameter equal to an inner diameter of the ventricular segment;
a shim attached to an exterior of the atrial segment, at least a portion of the shim being larger than the inner diameter of the tube holder for preventing migration of the tube by traction of rollers of the peristaltic pump.

24. The tube of claim 23 wherein an exterior surface of the shim has a conical configuration.

25. A method of using a peristaltic pump and tubing therefore, comprising the steps:
a) providing a peristaltic pump and a tube, the peristaltic pump comprising a C-shaped tube-holder and a roller pump head assembly wherein the C-shaped tube-holder snuggly fits an atrial segment of the tube and prevents the tube from migrating through a pump raceway, a narrow linear gap between the C-shaped tube-holder and the roller pump head assembly providing an entrance through which a portion of an arterial segment of the tube can be passed into the C-shaped tube-holder;
b) inserting the arterial segment of the tube through the C-shaped tube-holder;
c) pulling a length of the arterial segment of the tube through and past an exterior surface of an anterior wall of a roller assembly spool of the pump;
d) introducing an appropriate length of the arterial segment lengthwise through the gap between a superior rim of the anterior wall of the roller assembly spool and an inferior rim of the roller raceway until the length of the arterial segment of tube is within a space between the raceway and the rollers;
e) pulling the tube in a direction that lies within a plane between and parallel with two walls of the roller assembly spool while rotating the roller assembly spool until the ventricular segment of the tube has entered between the rollers and the raceway within the roller pump housing, and until the outside circumference of a tapered transitional segment of the tube becomes snuggly engaged within the inside circumference of the C-shaped tube-holder.

26. The method of claim 25 wherein the tube holder is integral with a housing of the pump.
